(19) United States
(12) Patent Application Publication
(10) Pub. No.: US 2003/0095282 A1
(43) Pub. Date: May 22, 2003

(54) Distributed printing system and distributed printing method

(76) Inventors: Yusuke Suzuki, Tokyo (JP); Yasushi Ohwa, Tokyo (JP)

Correspondence Address: FOLEY AND LARDNER, SUITE 500, 3000 K STREET NW, WASHINGTON, DC, 20007, US

(21) Appl. No.: 09/989,685

(22) Filed: Nov. 21, 2001

(51) Int. Cl. B41B 1/00; G06F 15/00

(52) U.S. Cl. 358/1.15; 358/1.13

(57) ABSTRACT

A distributed printing system and a distributed printing method are provided in which when print requests rush into a printer controller, a load is also made to be borne by a print client so as to perform processing in a well balanced manner. The distributed printing system of the present invention includes a print client 101 for creating PDL data based on a print request of a user, a printer controller 102 for delivering raster data created after raster image processing of the PDL data thus created to a printer engine 103 to print the raster data, and an RIP distribution control means capable of making the raster image processing distributed among and performed by the print client and the printer controller This RIP distribution control means includes RIP function parts 13a, 23b arranged in the above-mentioned print client and printer controller, respectively an RIP host selection function part 21 and an RIP host data part 22 for making the RIP function part 13a of the print client perform raster image processing when an amount of accumulation waiting for raster image processing in the printer controller becomes equal to or greater than a threshold.

### BACKGROUND OF THE INVENTION

1. Field of the Invention

The present invention relates to a distributed printing system and a distributed printing method, and more specifically, it relates to a distributed printing system and a distributed printing method including a print client for generating PDL data based on a print request of a user, and a printer controller for delivering raster data created after raster image processing of the PDL data created by the print client to a printer engine for printing.

2. Description of the Related Art

FIG. 33 is a block diagram explaining the construction of a known printing system. This printing system includes a print client 991 in the form of a computer which accepts a print request of a user, a printer controller 992 connected with the print client 991 through a communications path TRA, and a printer engine 993 connected with the printer controller 992 through a communications path TRB. The print client 991 is comprised of a computer as its main component, includes an application part 911, a printer driver 912 and a PDL creation function part 912a, and transmits print data based on the print request of the user as PDL data, which is described by a PDL (Page Description Language), through the data transmission communications path TRA. The printer controller 992 is also comprised of a computer as its main component, includes an RIP function part 923b for performing RIP (Raster Image Processing), creates print image data (raster data=bitmap data created for enabling printing) based on the PDL data received through the communications path TRA, and outputs it to the data transmission communications path TRB. The printer engine 993 performs printing based on the raster data received through the communications path TRB.

In the above case, the application part 911 of the print client 991 holds various application programs for processing print requests of the user, etc., in the print client 991. The PDL creation function part 912a creates PDL data from print data based on a user's request. The printer driver 912 including the PDL creation function part 912a instructs the PDL creation function part 912a according to the print request of the user received by the printer controller 992 so as to prepare the PDL data, and transmits the PDL data thus prepared to the printer controller 992 through the communications path TRA. The RIP function part 923b of the printer controller 992 interprets the PDL data that is received by the printer controller 992, performs the raster image processing of converting the PDL data into raster data for printing. In addition, the printer controller 992 transmits the converted raster data to the printer engine 993 through the communications path TRB.

In the known printing system as described above, the load on the RIP function part 923b of the printer controller 992, which performs raster image processing, is very large among other parts performing various processing. As a result, in cases where a lot of print requests rushes into the printer controller 993, there arises an absurd situation that though the printer engine 993 has ample room for printing, the printer controller 992 could not continuously output the raster data to the printer engine 993, thus giving rise to a problem of reducing the print processing efficiency of the printing system.

### SUMMARY OF THE INVENTION

The present invention is intended to obviate the problem as referred to above, and has for its object to provide a distributed printing system and a distributed printing method which are capable of swiftly processing print requests, even if rushing into a printer controller, in a well balanced manner without applying a heavy load to an RIP function part of a printer controller alone.

In order to solve the above-mentioned problem, the present invention resides in a distributed printing system comprising: a print client for creating PDL data based on a print request of a user; a printer controller for delivering raster data, which is created by subjecting the PDL data created by the print client to raster image processing, to a printer engine so as to be printed thereby; and RIP distribution control means capable of making the raster image processing distributed among and performed by the print client and the printer controller In this case, it can be characterized in that the RIP distribution control means distributes the raster image processing based on an amount of accumulation of the PDL data waiting for the raster image processing. Moreover, in such a case, it can be characterized in that the RIP distribution control means determines the amount of accumulation of the PDL data based on PDL feature data corresponding to an amount of raster image processing of the PDL data. In addition, the distributed printing system of the present invention can be characterized in that the RIP distribution control means distributes the raster image processing based on RIP host data which is data related to the processing performance of the print client. Here, note that the processing performance includes at least one of a raster image processing speed, a memory capacity, and a data transmission time.

Also, in the present invention, the RIP distribution control means comprises RIP function parts arranged in the printer controller and the print client, respectively; and RIP host selection control means arranged in the printer controller for determining, upon receipt of a notification of transmission of PDL data from the print client, whether an amount of accumulation of PDL data waiting for raster image processing when the PDL data to be transmitted from the print client is received becomes equal to or greater than a prescribed threshold, and for issuing an instruction such that the print client performs raster image processing of the PDL data by using its own RIP function part when the amount of accumulation of PDL data waiting for raster image processing becomes equal to or greater than the threshold.

In addition, in the present invention, a plurality of print client members are arranged as the print client, and the RIP host selection control means comprises: an RIP host data part arranged in the printer controller for storing RIP host data which is data related to the processing performance of each print client member; and an RIP host selection function part for selecting one of the plurality of print client members which has the highest processing performance while referring to the RIP host data when the amount of accumulation of the PDL data waiting for raster image processing becomes equal to or greater than a prescribed threshold, and for instructing the print client member thus selected in such a manner that raster image processing of the PDL data is carried out by the selected print client member while using its own RIP function part,

Moreover, in the present invention, RIP execution permission means is provided in the RIP function part arranged in each print client member in such a manner that the user can preset whether an instruction of raster image processing from the printer controller is acceptable.

Further, in the present invention, a plurality of print client members are arranged as the print client, and the RIP host selection control means comprises: an RIP host data part arranged in the printer controller for storing RIP host data which is data related to the processing performance of each print client member; and an RIP host selection function part for selecting those of the plurality of print client members which the RIP execution permission means permits acceptance of an raster image processing instruction from the printer controller when the amount of accumulation of the PDL data waiting for raster image processing becomes equal to or greater than a prescribed threshold, further selecting one of the thus selected print client members which has the highest processing performance while referring to the RIP host data, and instructing the print client member thus selected in such a manner that raster image processing of the PDL data is carried out by the selected print client member while using its own RIP function part.

Further, in the present invention, the RIP distribution control means comprises: RIP function parts arranged in the printer controller and the print client, respectively; a PDL analysis function part arranged in the print client for extracting PDL feature data corresponding to an amount of raster image processing of the PDL data; and RIP host selection control means arranged in the printer controller for determining, upon receipt of a notification of transmission of PDL data from the print client, based on the PDL feature data from the PDL analysis function part whether the amount of accumulation of PDL data waiting for raster image processing when the PDL data to be transmitted from the print client is received becomes equal to or greater than a prescribed threshold, and for issuing an instruction such that the print client performs raster image processing of the PDL data by using its own RIP function part when the amount of accumulation of PDL data waiting for raster image processing becomes equal to or greater than the threshold.

Further, in the present invention, the PDL feature data extracted by the PDL analysis function part comprises the number of pages of the PDL data.

Further, in the present invention, a plurality of print client members are arranged as the print client, and the RIP host selection control means comprises: an RIP host data part arranged in the printer controller for storing RIP host data which is data related to the processing performance of each print client member; and an RIP host selection function part for selecting one of the plurality of print client members which has the highest processing performance while referring to the RIP host data when the amount of accumulation of the PDL data waiting for raster image processing becomes equal to or greater than a prescribed threshold, and for instructing the print client member thus selected in such a manner that raster image processing of the PDL data is carried out by the selected print client member while using its own RIP function part.

Further, in the present invention, the RIP distribution control means comprises: RIP function parts arranged in the printer controller and the print client, respectively; a PDL analysis function part arranged in the printer controller for extracting PDL feature data corresponding to an amount of raster image processing of the PDL data; and RIP host selection control means for determining, upon receipt of a notification of transmission of PDL data from the print client, based on the PDL feature data from the PDL analysis function part whether an amount of accumulation of PDL data waiting for raster image processing when the PDL data to be transmitted from the print client is received becomes equal to or greater than a prescribed threshold, and for issuing an instruction such that the print client performs raster image processing of the PDL data by using its own RIP function part when the amount of accumulation of PDL data waiting for raster image processing becomes equal to or greater than the threshold.

Further, in the present invention, a plurality of print client members are arranged as the print client, and the RIP host selection control means comprises: an RIP host data part arranged in the printer controller for storing RIP host data which is data related to the processing performance of each print client member, and an RIP host selection function part for selecting one of the plurality of print client members which has the highest processing performance while referring to the RIP host data when the amount of accumulation of the PDL data waiting for raster image processing becomes equal to or greater than a prescribed threshold, and for instructing the print client member thus selected in such a manner that raster image processing of the PDL data is carried out by the selected print client member while using its own RIP function part.

Further, in the present invention, the RIP distribution control means comprises: a PDL analysis function part arranged in the print client for extracting PDL feature data corresponding to an amount of raster image processing of the PDL data, and a notification function part having a function of downloading control data from the printer controller; and RIP host selection control means arranged in the printer controller for determining, upon receipt of a notification of transmission of PDL data from an RIP module storing a control program for raster image processing and from the print client, based on the PDL feature data extracted by the PDL analysis function part whether an amount of accumulation of PDL data waiting for raster image processing when the PDL data to be transmitted is received becomes equal to or greater than a prescribed threshold, and for sending control data of the RIP module to the print client when the amount of accumulation of PDL data waiting for raster image processing becomes equal to or greater than the threshold, and issuing an instruction such that the print client performs raster image processing of the PDL data by using the control data received by the print client.

Further, in the present invention, a plurality of print client members are arranged as the print client, and the printer controller selects one of the plurality of print client members which has the highest processing performance while referring to the RIP host data when the amount of accumulation of the PDL data waiting for raster image processing becomes equal to or greater than a prescribed threshold, and makes the notification function part of the print client member thus selected download a control program for raster image processing sent from the RIP module.

Further, in the present invention, a host data collection part for collecting RIP host data of each print client member and transmitting the RIP host data thus collected to the RIP host data part at appropriate times is arranged in each print client member.

Further, the present invention resides in a distributed printing method comprising: a PDL data creation step for creating PDL data in a print client based on a print request of a user; a distribution step for distributing the PDL data to the print client and a printer controller; a raster image processing step for acquiring raster data by performing raster image processing of the distributed PDL data in the print client or the printer controller; and a printing step for delivering the raster data acquired through the raster image processing to a printer engine to print the raster data.

Further, the distributed printing method of the present invention is characterized in that in the distribution step, the raster image processing is distributed based on an amount of accumulation of the PDL data waiting for raster image processing.

Further, the distributed printing method of the present invention is characterized in that the amount of accumulation of the PDL data is determined based on PDL feature data corresponding to an amount of raster image processing of the PDL data.

Further, the distributed printing method of the present invention is characterized in that in the distribution step, the raster image processing is distributed based on RIP host data which is data related to the processing performance of the print client.

Further the distributed printing method of the present invention is characterized in that the processing performance includes at least one of a raster image processing speed, a memory capacity, and a data transmission time.

Further, the distributed printing method of the present invention is characterized in that the distribution step comprises: a determination step for determining, upon receipt of a notification of transmission of PDL data from the print client, in the print controller whether an amount of accumulation of the PDL data waiting for raster image processing when the PDL data to be transmitted is received becomes equal to or greater than a prescribed threshold; and an RIP host selection step for issuing an instruction such that the print client performs raster image processing of the PDL data by using its own RIP function part when the amount of accumulation of the PDL data becomes equal to or greater than the threshold.

Further, the distributed printing method of the present invention is characterized in that in the RIP host selection step, one of a plurality of print client members which has the highest processing performance is selected, and an instruction is issued to the print client member thus selected in such a manner that raster image processing of the PDL data is carried out by the selected print client member while using its own RIP function part.

Further, the distributed printing method of the present invention is characterized in that an RIP execution permission step is provided in each print client member in such a manner that the user can preset whether an raster image processing instruction from the printer controller is acceptable.

Further, the distributed printing method of the present invention characterized in that the RIP host selection step comprises: a step for selecting those of the plurality of print client members which are permitted to accept an raster image processing instruction from the printer controller in the RIP execution permission step; a step for referring to RIP host data for the print client members thus selected; and a step for further selecting one of the selected print client members which has the highest processing performance; wherein an instruction is given to the selected print client member such that the PDL data is subjected to raster image processing by using its own RIP function part.

Further, the distributed printing method of the present invention is characterized in that the distribution step comprises: a step for extracting PDL feature data corresponding to an amount of raster image processing of the PDL data; a determination step for determining, upon receipt of a notification of transmission of PDL data from the print client to the print controller, based on the PDL feature data whether an amount of accumulation of the PDL data waiting for raster image processing when the PDL data to be transmitted is received becomes equal to or greater than a prescribed threshold; and an RIP host selection step for issuing an instruction such that the print client performs raster image processing of the PDL data by using its own RIP function part when the amount of accumulation of the PDL data becomes equal to or greater than the threshold.

Further, the distributed printing method of the present invention is characterized in that the step for extracting PDL feature data is performed on a print client side.

Further, the distributed printing method of the present invention is characterized in that the step for extracting PDL feature data is performed on a printer controller side.

Further, the distributed printing method of the present invention is characterized in that the PDL feature data comprises the number of pages of the PDL data.

Further, the distributed printing method of the present invention is characterized in that in the RIP host selection step, when there are a plurality of print client members, one of the plurality of print client members having the highest processing performance is selected, and an instruction is given to the selected print client member so that the PDL data is subjected to raster image processing by using its own RIP function part.

Further, the distributed printing method of the present invention is characterized in that the RIP host selection step includes a step for transmitting control data of an RIP module from the printer controller to the print client when it is determined that the amount of accumulation of the PDL data becomes equal to or greater than the threshold, and for issuing an instruction such that the print client performs raster image processing of the PDL data by using the control data received.

Further, the distributed printing method of the present invention is characterized in that when the print client comprises a plurality of print client members, one of the print client members which has the highest processing performance is selected by referring to RIP host data.

Further, the distributed printing method of the present invention is characterized by comprising a host data collection step for collecting RIP host data of each of print client members and transmitting the RIP host data thus collected to the printer controller at appropriate times.

According to the constructions as described above, even if print requests rush into the printer controller, the RIP distribution control means can make the raster image processing appropriately distributed among and processed by the print client and the printer controller, so that the raster image processing can be prevented from stagnating in the printer controller, thereby enabling the raster image processing to be carried out swiftly.

### BRIEF DESCRIPTION OF THE DRAWINGS

FIG. 1 is a block diagram illustrating a first embodiment of a distributed printing system of the present invention.

FIG. 2 is a view illustrating memory contents stored in an RIP host data of FIG. 1.

FIG. 3 is a view illustrating memory contents stored in an RIP job management data part of FIG. 1.

FIG. 4 is a flow chart explaining an operation of an RIP host selection function part of FIG. 1 to select an RIP host.

FIG. 5 is a flow chart explaining the operation of a printer controller of FIG. 1.

FIG. 6 is a flow chart explaining the operation of a print client of FIG. 1.

FIG. 7 is a block diagram illustrating a second embodiment of a distributed printing system.

FIG. 8 is a view illustrating contents stored in an RIP host data part of the distributed printing system shown in FIG. 7.

FIG. 9 is a flow chart explaining the RIP host selection procedure in an RIP host selection function part of the distributed printing system shown in FIG. 7.

FIG. 10 is a flow chart explaining the operation of a print client or a third party client in the distributed printing system of FIG. 7.

FIG. 11 is a flow chart explaining the operation of a printer controller of the distributed printing system shown in FIG. 7.

FIG. 12 is a block diagram illustrating construction of a third embodiment of a distributed printing system of the present invention.

FIG. 13 is a view illustrating the contents of data stored in an RIP host data part of the distributed printing system shown in FIG. 12.

FIG. 14 is a view illustrating the contents of data stored in an RIP job management data part of the distributed printing system shown in FIG. 12.

FIG. 15 is a flow chart explaining the RIP host selection procedure performed by an RIP host selection function part of the distributed printing system shown in FIG. 12.

FIG. 16 is a flow chart explaining the operation of a printer controller of the distributed printing system shown in FIG. 12.

FIG. 17 is a flow chart explaining the operation of a print client of the distributed printing system shown in FIG. 12.

FIG. 18 is a block diagram illustrating the construction of a fourth embodiment of a distributed printing system of the present invention.

FIG. 19 is a view illustrating the contents of data stored in an RIP host data part of the distributed printing system shown in FIG. 18.

FIG. 20 is a view illustrating the contents of data stored in an RIP job management data part of the distributed printing system shown in FIG. 18.

FIG. 21 is a flow chart explaining the RIP host selection procedure performed by an RIP host selection function part of the distributed printing system shown in FIG. 18.

FIG. 22 is a flow chart explaining the operation of a print client or a third party client in the distributed printing system of FIG. 18.

FIG. 23 is a flow chart explaining the operation of a printer controller of the distributed printing system shown in FIG. 18.

FIG. 24 is a block diagram illustrating the construction of a fifth embodiment of a distributed printing system of the present invention.

FIG. 25 is a block diagram illustrating the construction of a sixth embodiment of a distributed printing system of the present invention.

FIG. 26 is a block diagram illustrating the construction of a seventh embodiment of a distributed printing system of the present invention.

FIG. 27 is a view illustrating an indication of downloading on a display of a print client of the distributed printing system shown in FIG. 26.

FIG. 28 is a block diagram illustrating the construction of an eighth embodiment of a distributed printing system of the present invention.

FIG. 29 is a block diagram illustrating the construction of a ninth embodiment of a distributed printing system of the present invention.

FIG. 30 is a block diagram illustrating the construction of a tenth embodiment of a distributed printing system of the present invention.

FIG. 31 is a flow chart explaining an operation of a printer controller to select an RIP host in the distributed printing system shown in FIG. 30.

FIG. 32 is a flow chart explaining an operation of selecting an RIP host in the distributed printing system of the present invention in cases where an RIP estimation time, which is the time required for performing the raster image processing upon selection of the RIP host, is assumed to be a criterion while taking into consideration a data transmission estimation time for transmitting data to the printer controller.

FIG. 33 is a block diagram explaining an example of the construction of a known printing system.

### DESCRIPTION OF THE PREFERRED EMBODIMENTS

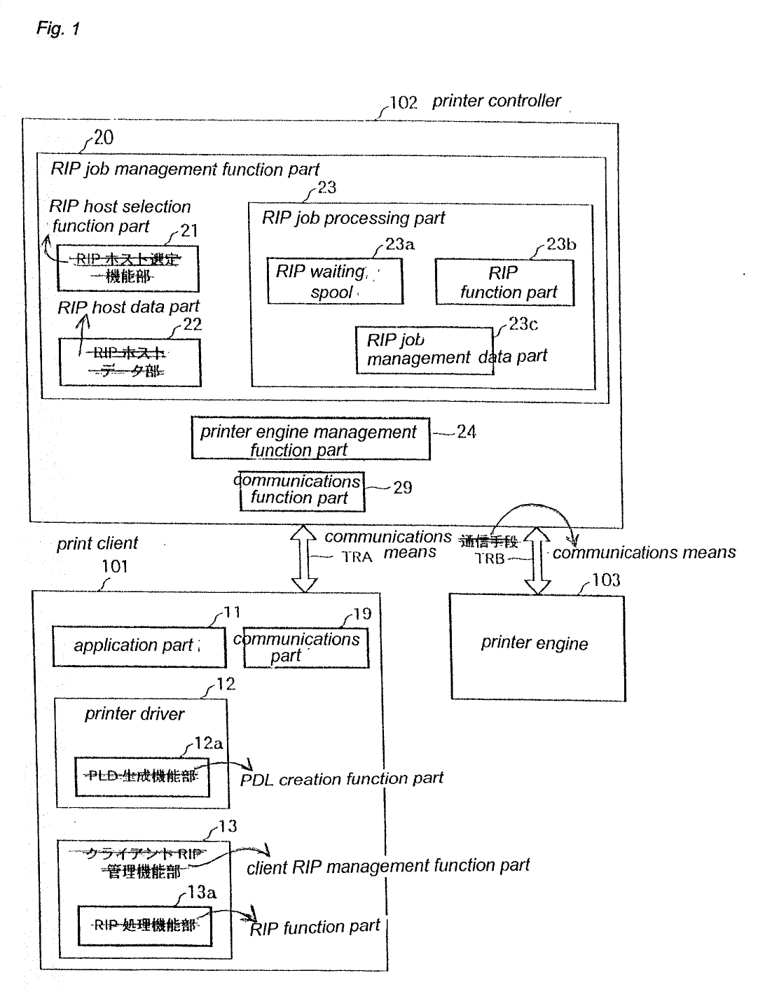

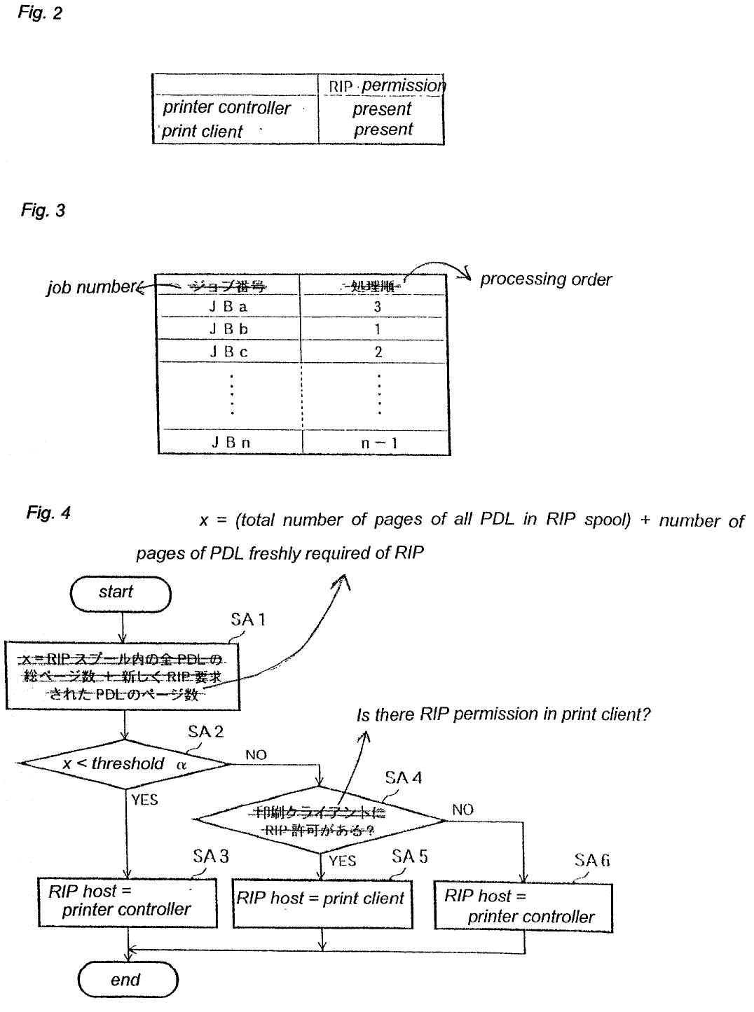

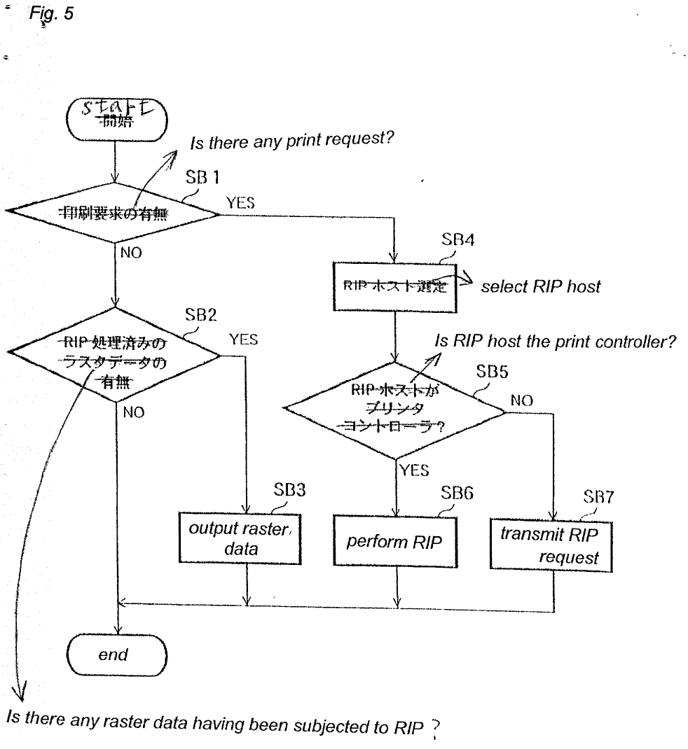

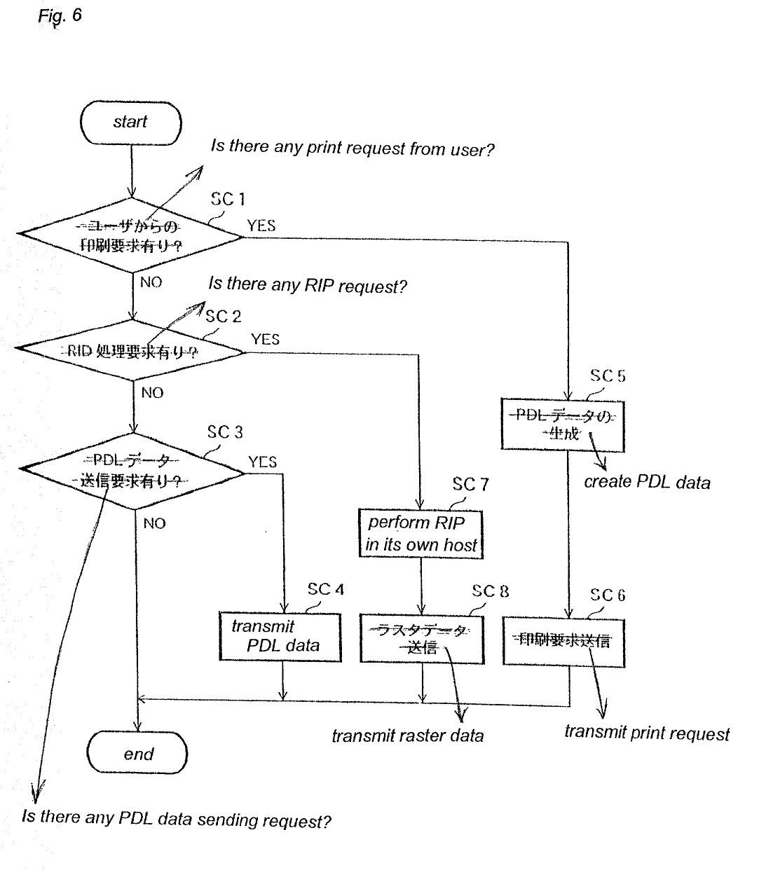

Hereinafter, preferred embodiments of the present invention will be described based on the accompanying drawings. FIG. 1 is a block diagram illustrating a first embodiment of a distributed printing system of the present invention. FIG. 2 is a view illustrating memory contents stored in RIP host data of FIG. 1. FIG. 3 is a view illustrating memory contents stored in an RIP job management data part of FIG. 1. FIG. 4 is a flow chart explaining an operation of an RIP host selection function part of FIG. 1 to select an RIP host. FIG. 5 is a flow chart explaining the operation of a printer controller of FIG. 1. FIG. 6 is a flow chart explaining the operation of a print client of FIG. 1.

(Embodiment 1)

The distributed printing system of FIG. 1 includes a print client 101 in the form of a computer which accepts a print request of a user, a communications means TRA, a printer controller 102, another communications means TRB, and a printer engine 103. First of all, reference will be made to the construction of the printer controller 102. The printer controller 102 is comprised of a computer, includes an RIP job management function part 20, a printer engine management function part 24 and a communications function part 29, and has arithmetic operation processing performance or processing power equal to or greater than that of the print client 101. The RIP job management function part 20 of this printer controller 102 includes an RIP host selection function part 21, an RIP host data part 22, and an RIP job processing part 23. In addition, the RIP job processing part 23 includes an RIP waiting spool 23a, an RIP function part 23b, and an RIP job management data part 23c.

The RIP job management function part 20 performs the management of raster image processing of respective PDL data by using the functions of respective parts to be described later, and creates raster data. The RIP host selection function part 21 has a function of sequentially selecting RIP hosts (subjects which perform raster image processing) while referring to the RIP host data. The RIP host data part 22 holds the RIP host data which is used by the RIP host selection function part 21 for sequentially selecting the RIP hosts. The RIP host data includes the processing performance or power of the print client 101 or the printer controller 102 used by the RIP host selection function part 21 for automatic determination. Here, to facilitate understanding, however, it is assumed that the RIP host data part 22 merely stores the presence or absence of permission as to whether raster image processing may be carried out or not, as shown in FIG. 2. This RIP host data is input beforehand by a manager through an RIP execution permission means such as a keyboard. The RIP job processing part 23 manages the PDL data based on the data of the RIP waiting spool 23a and the data of the Rip job management data part 23c, and controls the RIP function part 23b so as to sequentially perform the raster image processing on the PDL data and output raster data.

In the above case, the RIP waiting spool 23a stores and manages the PDL data waiting for raster image processing. The RIP job management data part 23c stores management information for the PDL data stored in the RIP waiting spool 23a. That is, the RIP job management data part 23c stores job numbers JBa, JBb, JBc, - - - , JBn, and order numbers 3, 1, 2, - - - , (n−1) of the raster image processing for the PDL data corresponding to the respective job numbers, as shown in FIG. 3 for instance. The RIP function part 23b analyzes the PDL data and creates the raster data so as to carry out drawing. The communications function part 29 communicates with the print client through the communications means TRA, and with the printer engine 103 through the communications means TRB. The printer engine management function part 24 delivers the raster data output from the RIP job management function part 20 to the printer engine 103 through the communications function part 29 and the communications means TRB. The printer engine 103 receives the raster data from the printer controller 102 through the communications means TRB, and prints the raster data thus received.

Next, reference will be made to the construction of the print client 101. The print client 101 includes an application part 11, a printer driver 12 having a PDL creation function part 12a, a client RIP management function part 13 having an RIP function part 13a, and a communications function part 19. The application part 11 serves to provide a user with services concerning printing through an interactive interface such as a menu on a display, etc. The printer driver 12 drives the PDL creation function part 12a according to a print request of the user The PDL creation function part 12a creates PDL data according to the print request. The client RIP management function part 13 drives the RIP function part 13a according to an instruction of the printer controller 102, so as to execute raster image processing. The RIP function part 13a analyzes PDL data and creates raster data. The communications function part 19 transmits and receives data to and from the communications function part 29 through the communications means TRA.

Now, reference will be made to the RIP host selection procedure of the RIP host selection function part 21 of the above-mentioned printer controller 102 while referring to the flow chart of FIG. 4. The RIP host selection function part 21 calculates the number of pages X which is the total number of pages PG0 of all the PDL data, which is held by the RIP waiting spool (RIP spool) 23a and waiting for raster image processing, added by the number of pages PG1 of the PDL data newly required of the raster image processing (SA1). Then, it is determined whether the number of pages X thus calculated is less than a prescribed threshold α (SA2). When the number of pages X is less than the threshold α, the printer controller 102 is selected as an RIP host (SA3; in this case, the printer controller 102 is always assumed to be granted, as a rule, permission to perform raster image processing, as shown in FIG. 2). When the number of pages X is equal to or greater than the threshold α in step SA2, it is determined whether there is RIP permission in the print client 101 (SA4). When there is RIP permission in the print client 101, the print client 101 is selected as an RIP host (SA5). When there is no RIP permission in the print client 101 in step SA4, the printer controller 102 is selected as an RIP host because there is no other choice (SA6).

A processing operation of the printer controller 102 for outputting raster data will be described with reference to the flow chart of FIG. 5. It is first determined whether a print request has been received from the print client 101 (SB1). When there has been received no print request, it is determined whether there is any raster data which has been subjected to raster image processing (SB2). The raster data in this case includes the raster data that has been processed by the RIP function part 23b of the printer controller 102, and the raster data that has been subjected to raster image processing by the RIP function part 13a of the print client 101 and sent to the printer controller 102. When there is no raster data having been subjected to raster image processing in step SB2, the processing operation at this time is ended, but when there is some raster data having been subjected to raster image processing, the raster data is output to the printer engine 103 (SB3). When a print request is received in step SB1, the RIP host selection function part 21 selects an RIP host according to FIG. 4 (S B4). The printer controller 102 determines whether what has been decided as an RIP host is itself or the print client 101 (SB5). If the RIP host is the printer controller 102 itself, the printer controller 102 controls such that raster image processing is carried out by the RIP function part 23b (SB6), but If the RIP host is not the printer controller 102 itself, the printer controller 102 makes a request to the print client 101 so that the raster image processing of the PDL data concerned is carried out by the print client 101 (SB7).

Now, the operation of the print client 101 will be described with reference to the flow chart of FIG. 6. An operation system (OS) in the application part 11 determines whether a print request has been made from the user (SC1). When there is no print request in step SC1, the client RIP management function part 13 determines whether there is a RIP request from the printer controller 102 (SC2). When there is no RIP request in step SC2, the client RIP management function part 13 determines whether there is a PDL sending request (SC3). When there is no PDL sending request in step SC3, the control operation at this time is ended, but when there is a PDL sending request, PDL data is transmitted to the printer controller 102 (SC4).

When there is a print request in step SC1, the printer driver 12 drives the PDL creation function part 12a so that the data received from the application part 11 is converted into PDL data (SC5), and the client RIP management function part 13 transmits a print request to the printer controller 102 through the communications function part 19 and the communications means TRA (SC6; when the print client 101 receives a request for transmitting the PDL data from the printer controller 102 in response to this print request, the PDL data will be transmitted to the printer controller 102 in steps SC3 and SC4 of the next control operation.). When there is a RIP request in step SC2, the client RIP management function part 13 drives the RIP function part 13a in such a manner that the PDL data specified by the printer controller 102 is subjected to the raster image processing by means of the RIP function part 13a (SC7). In addition, the client RIP management function part 13 drives the RIP function part 13a so as to perform the raster image processing in step SC7, and transmits raster data thus created to the printer controller 102 through the communications function part 19 and the communications means TRA (SC8).

(Embodiment 2)

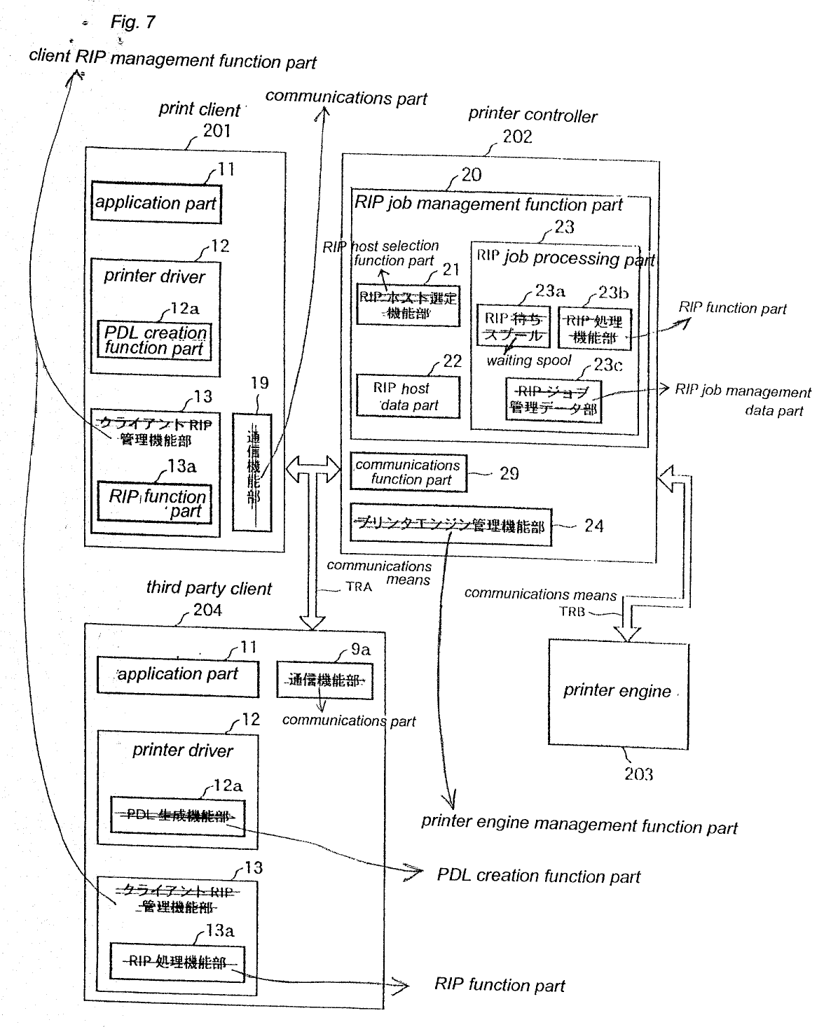

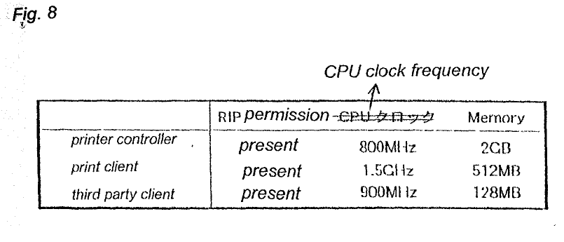

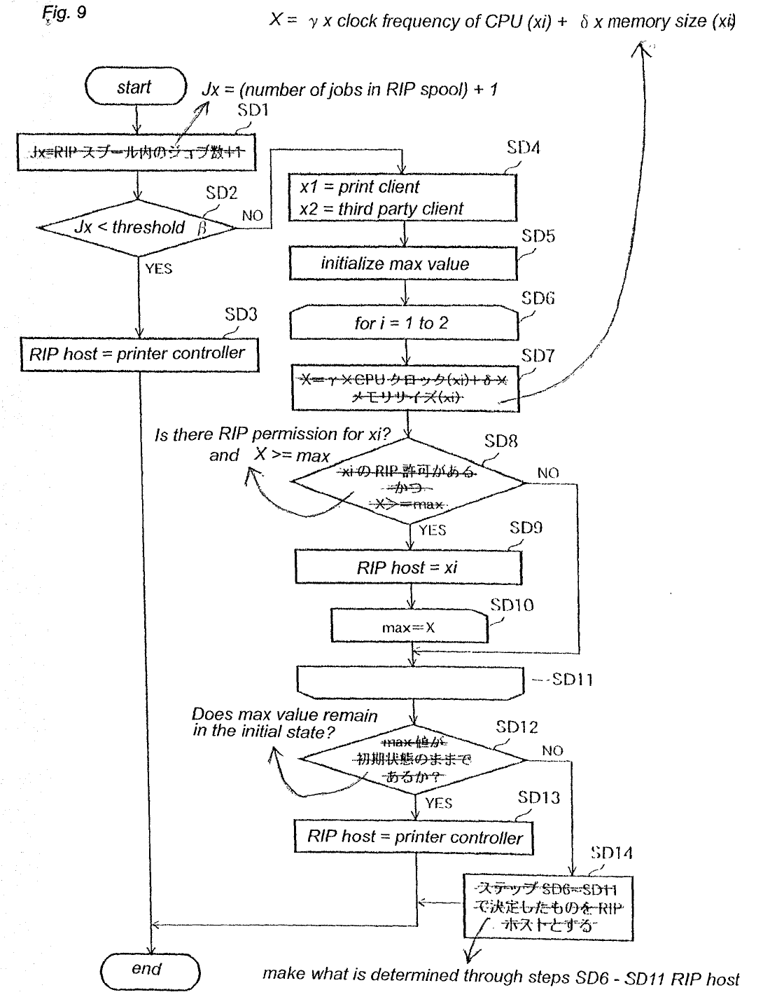

Next, reference will be made to a second embodiment of a distributed printing system of the present invention. FIG. 7 is a block diagram illustrating the second embodiment of the distributed printing system of the present invention. FIG. 8 is a view illustrating contents stored in an RIP host data part in the second embodiment shown in FIG. 7. FIG. 9 is a flow chart explaining the RIP host selection procedure in an RIP host selection function part shown in FIG. 7. The distributed printing system of FIG. 7 is constructed by adding a third party client (i.e., another print client, this name being used to facilitate understanding) other than the aforementioned print client to the first embodiment shown in FIG. 1. In this case, a third party client 204 is able to communicate with both of a print client 201 and a printer controller 202. Those parts of the third party client 204 which have the same names as those of the respective parts of the print client 201 have the same functions as those of the parts of the print client 201, respectively. Moreover, the third party client 204 is a computer which has substantially the same function as that of the print client 201 though there is a slight difference in their performance. In addition, in the RIP host selection procedure, the third party client 204 is a candidate for the RIP host, and the data of the third party client 204 is also stored in the RIP host data part 22.

Now, reference will be made to the RIP host selection procedure of the RIP host selection function part 21 in the distributed printing system of FIG. 7, while referring to FIG. 8 and FIG. 9. The print client 201, the printer controller 202 and the third party client 204 are registered in the RIP host data part 22 as candidates for the RIP host, and the presence or absence of permission of the raster image processing for each of these parts, the clock frequency of a CPU and the capacity of a memory are also stored in the RIP host data part 22, as shown in FIG. 8. Due to such registration, the RIP host selection procedure in the second embodiment differs slightly from that of the first embodiment. What is different is mainly the RIP host selection procedure when the printer controller 202 is not elected as an RIP host. That is, the difference is the selection procedure from step SD4 to step SD13 in FIG. 9. A part of the procedure in the first embodiment for determining from information on the RIP host data whether there is RIP permission for the print client is constructed according to the second embodiment such that data related to RIP permissions for the print client 201 and the third party client 204 is held, and when it is necessary to select either one of them, one of these clients, which is more suitable for calculation processing in view of the CPU performance and the memory size than the other, is automatically selected as an RIP host.

That is, the RIP host selection function part 21 newly calculates the total number of all jobs Jx by adding the number of jobs “1” freshly required of raster image processing to the number of all jobs already waiting for raster image processing, i.e., the number of all jobs stored in the RIP spool (SD1). Then, it is determined whether the number of jobs Jx thus calculated is less than a prescribed threshold β (SD2). When it is determined that the number of jobs Jx is less than the threshold β, the printer controller 202 is selected as an RIP host (SD3; in this case, the printer controller 202 is assumed to be granted permission to perform raster image processing, as shown in FIG. 2).

When it is determined in step SD2 that the number of jobs Jx is equal to or greater than the threshold β, the print client 201 and the third party client 204, which are computers other than the printer controller 202 and which are objects or candidates for an RIP host, are applied with identifiers “X1”, “X2”, respectively, so that they can be handled as selection objects or candidates (SD4). Then, the RIP host selection function part 21 initializes a max value which is a parameter representative of the performance of an RIP host (SD5). A loop for selection is set for all the computers (the print client and the third party client in this example) which can be selected as an RIP host (SD6; the meaning of the processing located between step SD6 and step SD11 is to repeat the processing from step SD7 up to step SD10 prior to step SD11 for the objects or candidates set in step SD12, and thereafter the control process shifts to step SD12 following the step SD11). In the second embodiment, the objects or candidates to be selected as an RIP host are two, Le., the print client 201 and the third party client 204, so this loop is set so as to perform two (i=1 to 2) processing in step SD6.

After the setting in step SD6 has been completed, a parameter representative of the performance of each of the computers, which can be selected as an RIP host, is calculated. This parameter is calculated based on the data registered in the RIP host data part 22. In the second embodiment, the clock frequency at which the CPU operates and the memory size are multiplied by constants γ and δ, respectively, and then the values thus calculated are summed up to provide a total sum. In this case, the constants γ and δ are the values decided beforehand, and the higher the calculation performance of a computer, the greater becomes the total sum value calculated here (SD7). It is determined whether there is raster image processing permission for a computer Xi to be selected as an RIP host, and also whether the processing performance of the computer calculated in step SD7 is greater than the performance value of another computer which has already been determined (SD8). When it is determined as a result of the determinations in step SD8 that the computer to be selected has RIP permission, and that the calculation performance of the computer to be selected is higher than that of the computer already determined as an RIP host selection object, the computer to be selected is determined as an RIP host (SD9), and the value representative of the performance of this computer is saved as a max value (SD10). Subsequently it is determined whether the max value is in the initial state or value (SD12). When the max value is in the initial state or value, there is no candidate for an RIP host, and hence the RIP host already selected is made a printer controller (SD13). On the other hand, when it is determined in step SD12 that the max value is not in the initial state, the print client 201 or the third party client 204 of identifier X1 or X2 determined as an RIP host is made as an RIP host (SD14).

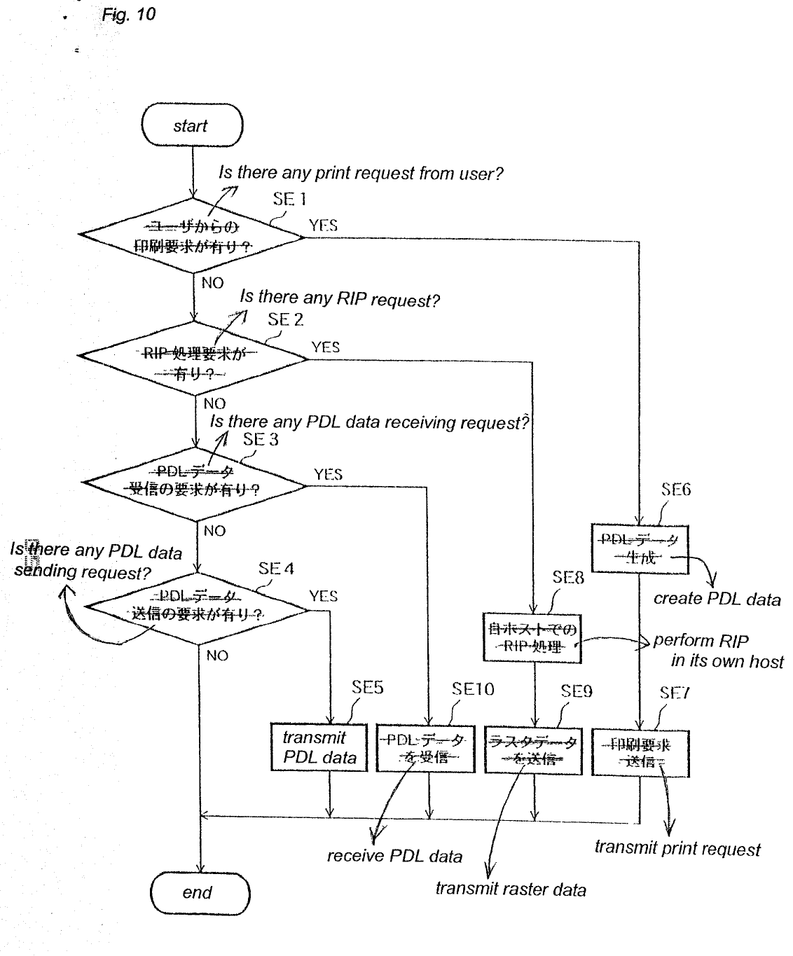

Now, the operation of the print client or the third party client in the distributed printing system of FIG. 7 will be described while referring to FIG. 10. In this case, the operations of both the clients are substantially the same and hence only the print client will be described. The print client 201 determines whether there is any print request from a user (SE1). When there is no print request as a result of the determination, it is further determined whether there is any request for raster image processing from the printer controller 202 (SE2). When there is no request for raster image processing as a result of the determination, it is further determined whether there is a request for receiving PDL data sent from the printer controller 202 (SE3). When there is no request for receiving the PDL data as a result of the determination, it is further determined whether there is a request of the printer controller 202 for transmitting PDL data (SE4). When there is no request for transmitting PDL data, the control process is ended, whereas when there is a request for transmitting PDL data, the PDL data is transmitted to the printer controller 202 (SE5).

When there is a print request from the user in the above-mentioned step SE1, the print client 201 creates PDL data (SE6), and transmits the presence of the print request to the printer controller 202 (the PDL data related to this print request is transmitted to the printer controller 202 as raster data for instance through the steps SE4 and SE5 or the steps SE2, SE8 and SE9 in the next control operation). When there is a RIP request from the printer controller 202 in step SE2, the printer controller itself is made an RPI host and performs the raster image processing of the PDL data concerned (SE8). The raster data after having been subjected to the raster image processing is transmitted to the printer controller 202 (SE9). When it is determined in step SE3 that there is a request for receiving the PDL data sent by the printer controller 202, the PDL data is received (SE10; this PDL data can be transmitted as raster data to the printer controller 202 through the steps SE2, SE8 and SE9).

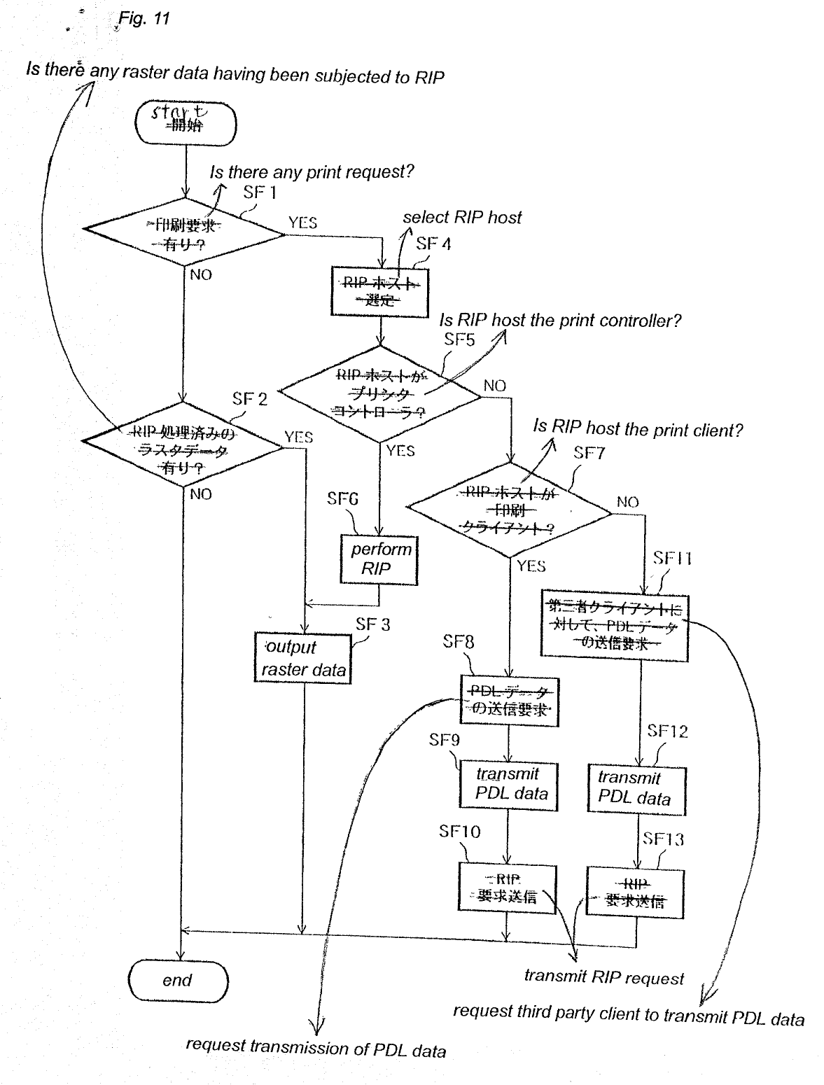

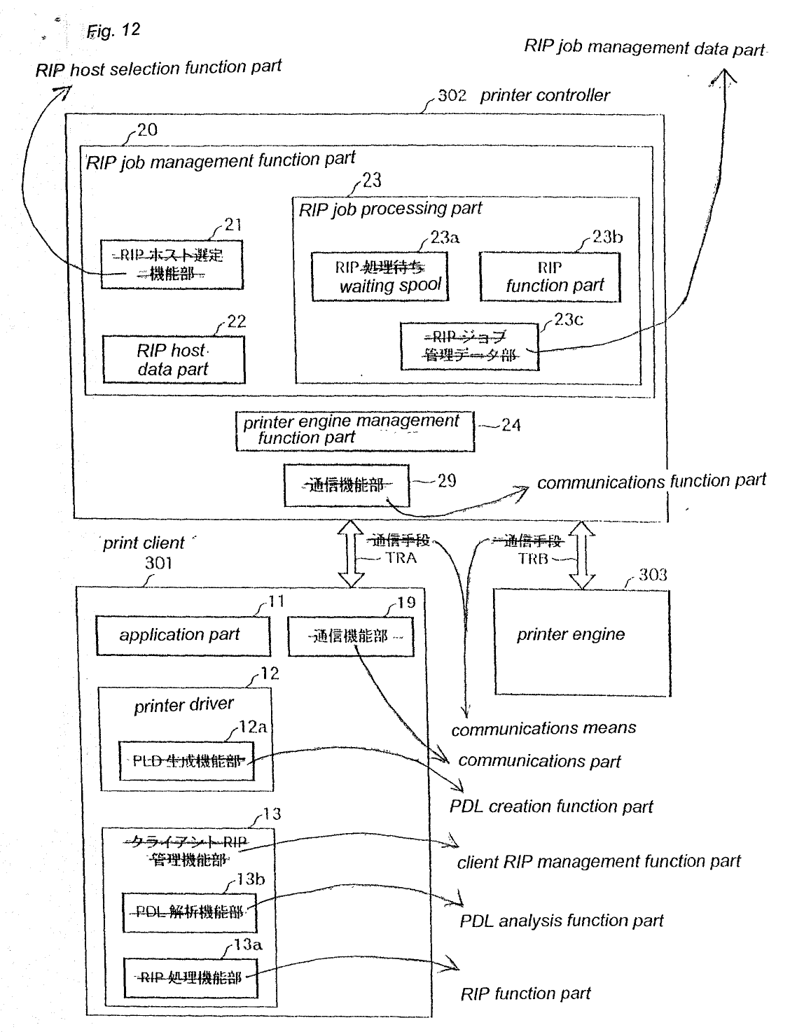

As can be seen from the above explanations about FIG. 9 and FIG. 10, the printer controller 202 in this example processes the PDL data by itself in principle for which raster image processing is requested, but when processing is congested, the printer controller 202 controls such that the raster image processing is executed by the print client 201 or the third party client, whichever is more suitable for such processing. Moreover, the PDL data with a print request from the print client 201 is delivered to the third party client 204, or the PDL data with a print request from the third party client 204 is delivered to the print client 201, so that the raster image processing of the PDL data may be carried out by the third party client or the print client. Then, the operation of the printer controller corresponding to the operation of the print client or the third party client shown in FIG. 10 will be described while referring to FIG. 11.

As shown in FIG. 11, the printer controller 202 determines whether there is a print request from the print client 201 or the third party client 204 (SF1). When there is no print request, it is determined whether there is any raster data which has been subjected to the raster image processing (SF2), and when there is no such raster data, the control process ends, but when there is some such raster data, the raster data is output to a printer engine 203 (SF3). When there is a print request in step SF1, an RIP host is selected in accordance with the operation as shown in FIG. 9 (SF4). It is determined whether the RIP host thus selected is the printer controller 202 (SF5). When the printer controller 202 is the RIP host as a result of the determination in step SF5, the printer controller 202 performs the raster image processing corresponding to the print request (SF6), and then the control process goes to step SF3. When the RIP host is not the printer controller 202 in the determination of step SF5, it is determined whether the RIP host is the print client 201 (SF7). If so, a request for receiving the PDL data to be transmitted is made to the print client 201 (SF8), and the PDL data is transmitted to the print client 201 (SF9; in this case, if the PDL data is for the print client 201, the control process jumps to step SF10 while skipping steps SF8 and SF9.). After the transmission of the PDL data has been completed, the printer controller 202 transmits such a request that the print client 201 should perform the raster image processing for the PDL data thus transmitted (SF10).

When it is determined in step SF7 that the RIP host is not the print client 201, the RIP host is the third party client 204 and hence the printer controller 202 makes a request for receiving the PDL data to be transmitted (SF11), and transmits the PDL data to the third party client 204 (SF12; in this case, if the PDL data is for the third party client 204, the control process jumps to step SF13 while skipping steps SF11 and SF12.). After the transmission of the PDL data has been completed, the printer controller 202 transmits such a request that the third party client 204 should perform the raster image processing for the PDL data thus transmitted (SF13). Here, note that although in this example, the printer controller 202 delivers the raster image processing to the print client 201 or the third party client 204 as necessary after having received the PDL data from the print client 201 or the third party client 204, control may be carried out so as to directly transmit the PDL data between the print client 201 and the third party client 204. Moreover, though the third party client is single in this example, there may be used a plurality of third party clients which are connected in parallel with each other. The use of a single third party client is to merely facilitate the explanation and understanding of the invention, and this can be applied to the following description.

(Embodiment 3)

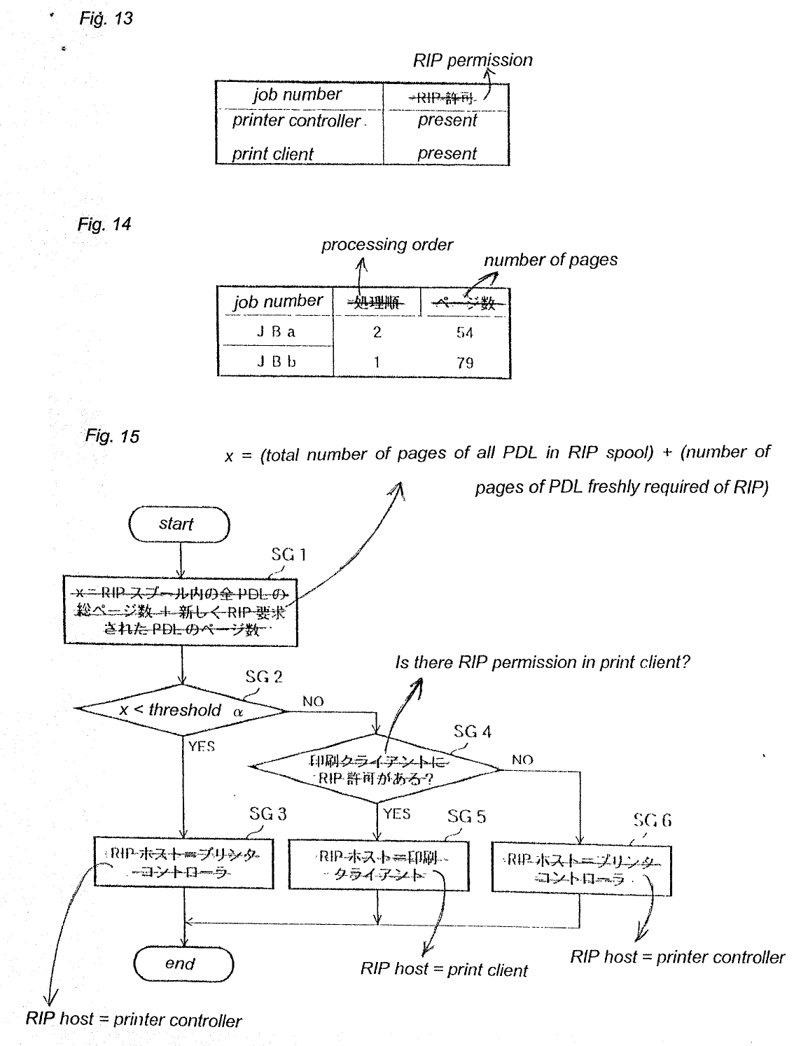

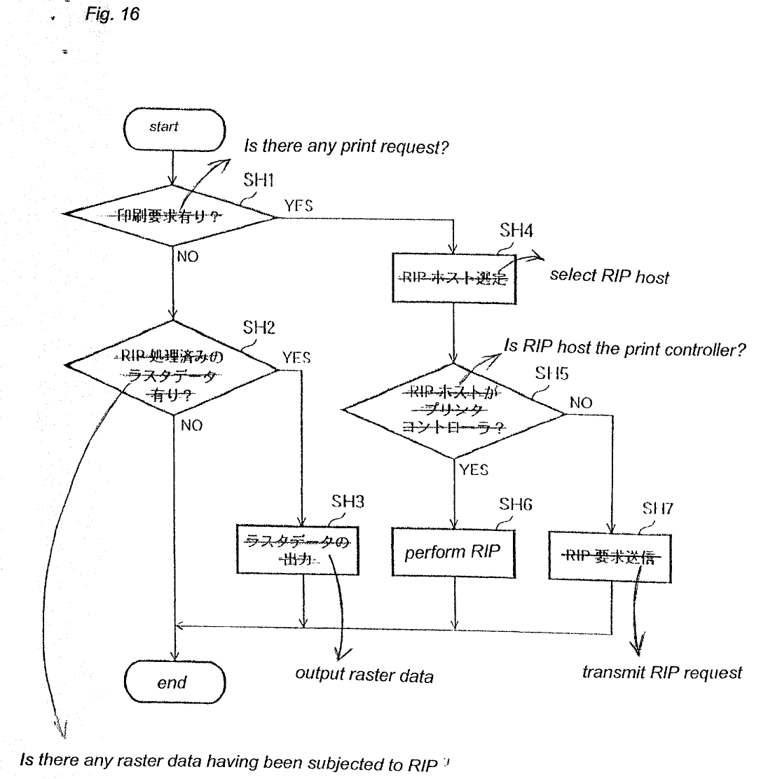

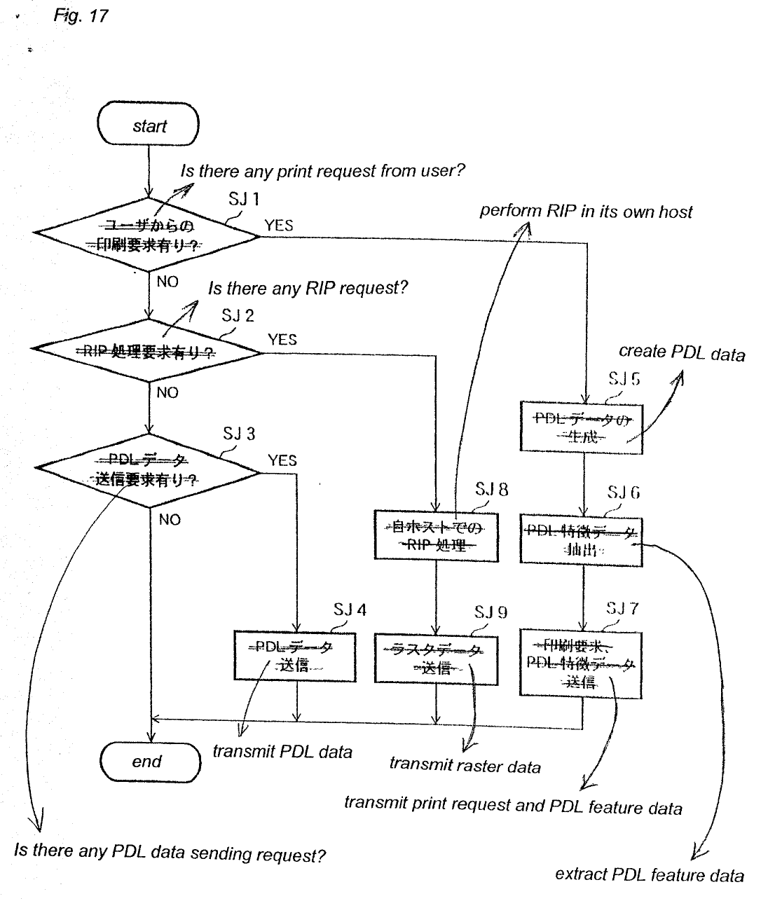

Now, reference will be made to a third embodiment of a distributed printing system of the present invention while referring to the drawings. FIG. 12 is a block diagram illustrating the construction of the third embodiment of the distributed printing system of the present invention. FIG. 13 is a view illustrating the contents of the data stored in an RIP host data part. FIG. 14 is a view illustrating the contents of the data stored in an RIP job management data part. FIG. 15 is a flow chart explaining the RIP host selection procedure in an RIP host selection function part. FIG. 16 is a flow chart explaining the operation of a printer controller. FIG. 17 is a flow chart explaining the operation of a print client.

The distributed printing system of FIG. 12 includes a print client 301, a communications means TRA, a printer controller 302, another communications means TRB, and a printer engine 303. This distributed printing system is different from the one shown in FIG. 1 in that the client RIP management function part of the print client has a PDL analysis function part, and it is also different therefrom in the processing of the printer controller resulting therefrom. Accordingly, an explanation concerning the PDL analysis function part will be mainly carried out, while omitting the explanation of the other parts. The PDL analysis function part 13b of the print client 301 analyzes the PDL data and extracts PDL feature data. The PDL feature data is data used to estimate the time required for processing when the PDL data is subjected to the raster image processing. Concretely, such data includes, for instance, the number of pages of the PDL data, the presence or absence and the size of each image contained therein, the number of images drawn through calculations, etc., and stated in other words, the quantities of features of the PDL data which influence the raster image processing time. In the example of FIG. 12, for the sake of easy understanding, the following description will be made with the number of pages of the PDL data being taken as PDL feature data. Here, let us assume that data related to raster image processing permission as shown in FIG. 13 is stored in the RIP host data part 22 of the printer controller 302, and that control data indicative of the order of processing and the PDL feature data as shown in FIG. 14 are stored in the RIP job management data part 23c.

First of all, reference will be made to the operation of the RIP host selection function part of the printer controller 302 while referring to FIG. 15. The RIP host selection function part 21 of the printer controller 302 is waiting for the raster image processing based on the number of pages of the PDL data that has been sequentially analyzed by the PDL analysis function part 13b of the print client 301, and sent to the printer controller 302. The total number of pages PG0 of all the PDL data stored in the RIP spool is added by the number of pages PG1 of the PDL data for which new raster image processing is requested, thus calculating the number of pages X (SG1). Here, note that the number of pages of each PDL data may be obtained by referring to the RIP job management data part 23c. Then, it is determined whether the number of pages X calculated in step SG1 is less than a prescribed threshold α (SG2).

When it is found in step SG2 that the number of pages X is less than the threshold α, the printer controller 302 is selected as an RIP host (SG3; in this case, it is assumed that as a rule, raster image processing permission is always given to the printer controller 302, as shown in FIG. 13.). When the number of pages X is equal to or greater than the threshold α in step SG2, it is determined whether there is raster image processing permission for the print client 301 (SG4). When the raster image processing is permitted to the print client 301, the print client 301 is selected as an RIP host (SG5). When the raster image processing is not permitted to the print client 301 in step SG4, the printer controller 302 is selected as an RIP host because there is no other choice (SG6).

Next, the processing operation related to the output of raster data of the printer controller 302 will be described while referring to the flow chart of FIG. 16. First, it is determined whether there is receipt of a print request from the print client 301 (SH1). When no print request is received, it is determined whether there is any raster data which has been subjected to the raster image processing (SH2). Note that the raster data in this case includes the raster data that has been subjected to raster image processing by the RIP function part 23b of the printer controller 302 and the raster data that has been subjected to raster image processing by the RIP function part 13a of the print client 301 and sent to the printer controller 302. When there is no raster data which has been subjected to the raster image processing in step SH2, the processing operation at this time is ended, but when there is some raster data having been subjected to raster image processing, the raster data is output to the printer engine 303 (SH3). When a print request is received in step SH1, the RIP host selection function part 21 selects an RIP host according to FIG. 15 (SH4). The printer controller 302 determines whether what has been determined as an RIP host is itself or the print client 301 (SH5). When the RIP host is the printer controller 302 itself, the printer controller 302 controls such that the RIP function part 23b performs the raster image processing (SH6), but when the RIP host is not the printer controller itself, the printer controller 302 makes a request such that the print client 301 should perform the raster image processing of the PDL data concerned (SH7).

The operation of the print client 301 will now be described while referring to the flow chart of FIG. 17. First, an operating system (OS) of the application part 11 determines whether there has been a print request from the user (SJ1). When there is no print request in step SJ1, the client RIP management function part 13 determines whether there is a RIP request from the printer controller 302 (SJ2). When there is no RIP request in step SJ2, it is determined whether there is a PDL sending request (SJ3). When there is no PDL sending request in step SJ3, the control operation at this time is ended, but when there is a PDL sending request, the PDL data is transmitted to the printer controller 102 (SJ4).

When there is a print request in step SJ1, the printer driver 12 drives the PDL creation function part 12a so that the data received from the application part 11 is converted into PDL data (SJ5), and PDL feature data is extracted by the PDL analysis function part 13b (SJ6). The client RIP management function part 13 transmits the print request and the PDL feature data to the printer controller 302 through the communications function part 19 and the communications means TRA (SJ7). When there is a RIP request in step SJ2, the client RIP management function part 13 operates in such a manner that the PDL data specified by the printer controller 302 is subjected to raster image processing by the RIP function part 13a (SJ8). In addition, the client RIP management function part 13 transmits the raster data thus subjected to raster image processing by the RIP function part 13a in step SJ8 to the printer controller 302 through the communications function part 19 and the communications means TRA (SJ9).

(Embodiment 4)

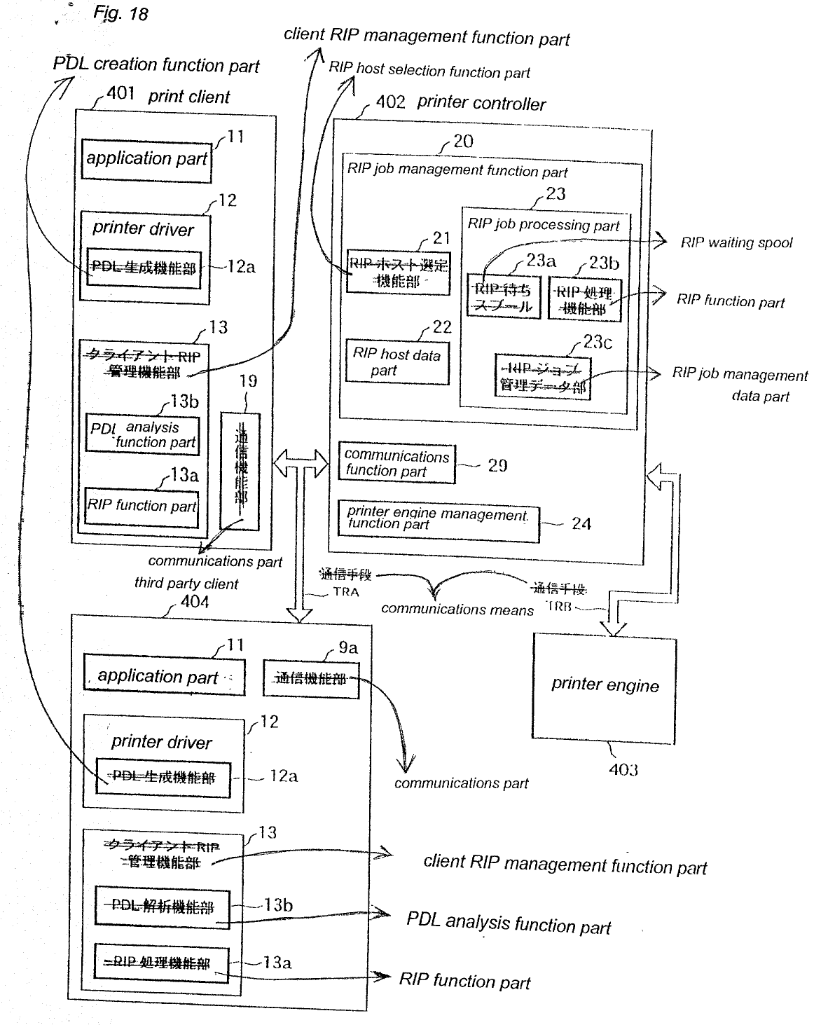

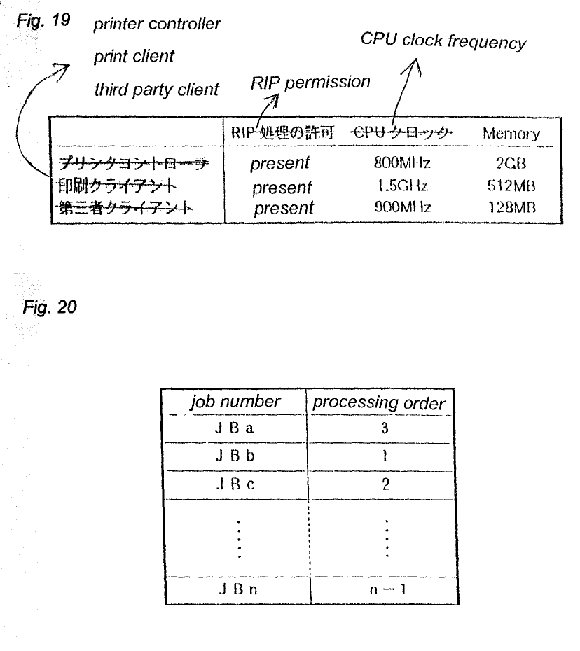

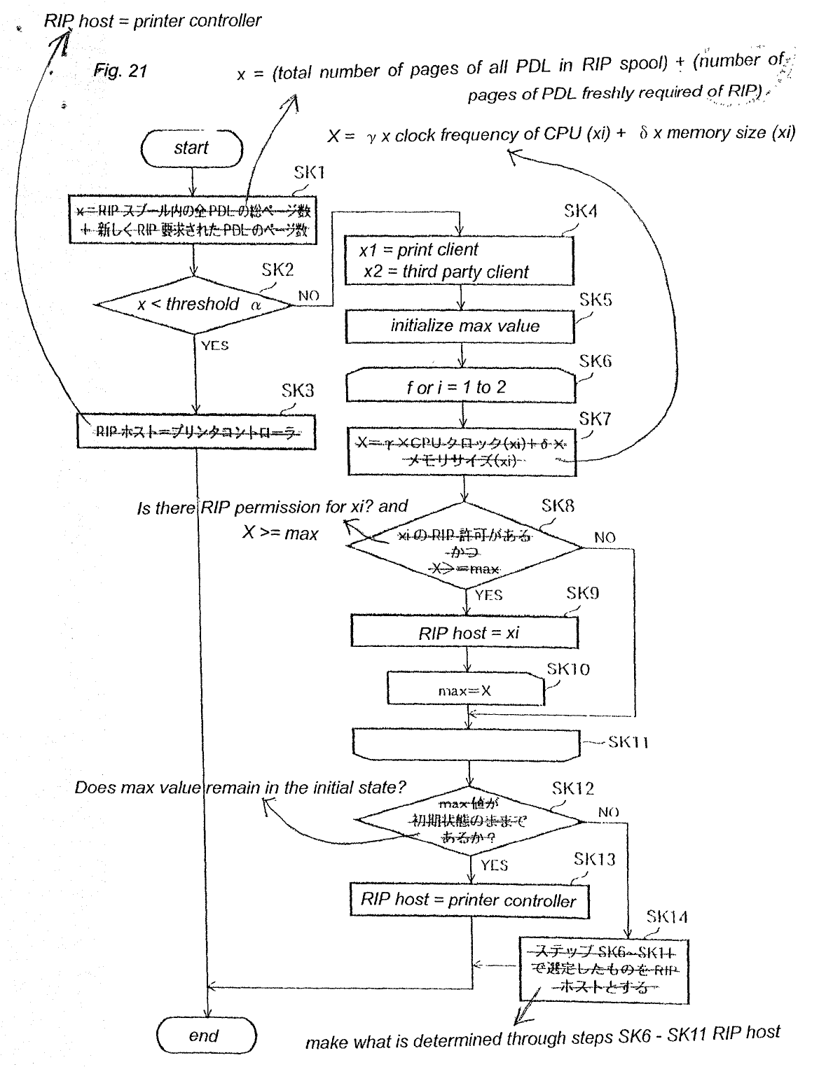

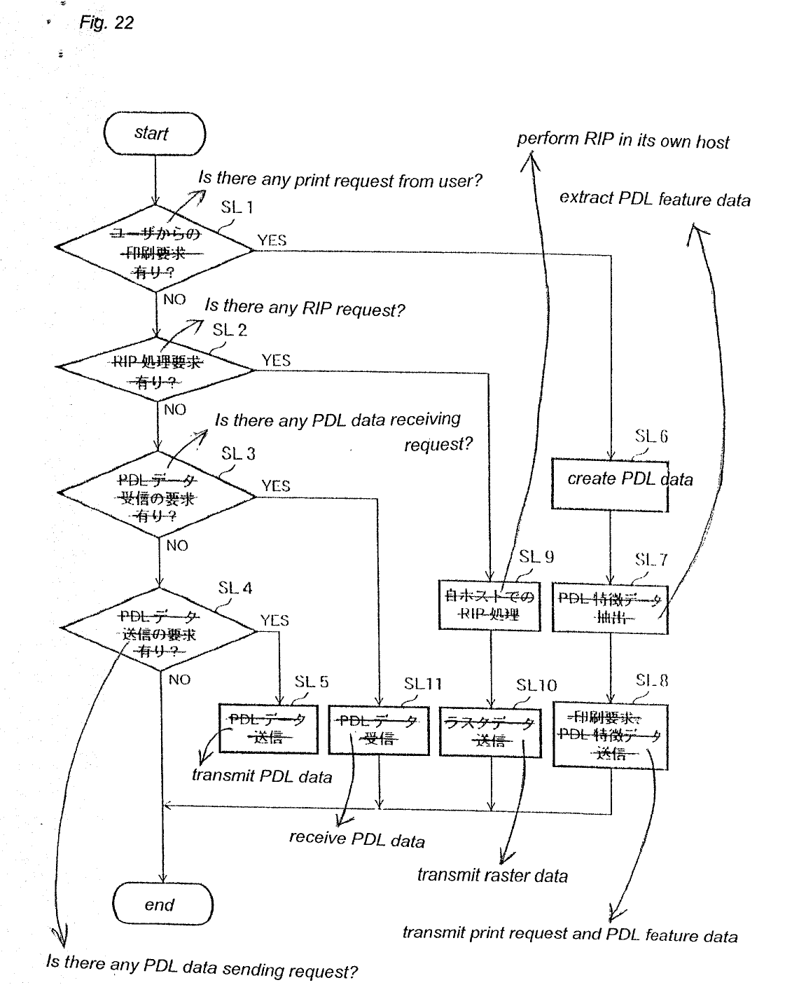

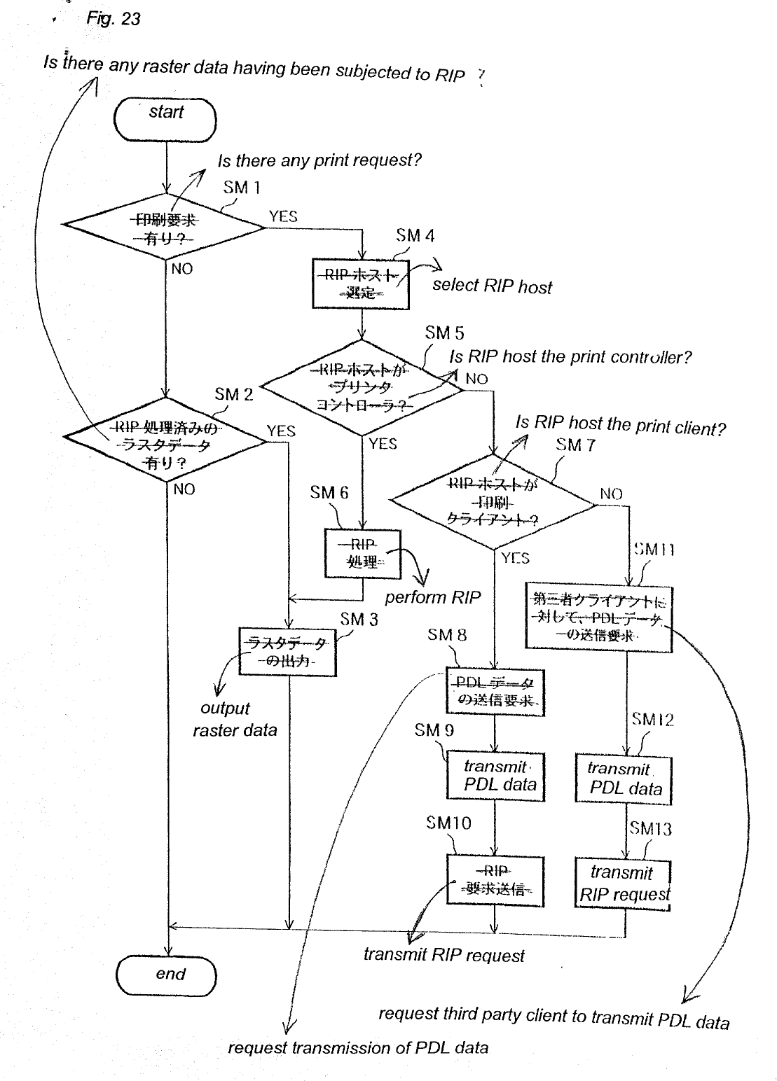

Next, reference will be made to a fourth embodiment of a distributed printing system of the present invention while referring to the drawings. FIG. 18 is a block diagram illustrating the construction of the fourth embodiment of the distributed printing system of the present invention. FIG. 19 is a view illustrating the contents of data stored in an RIP host data part. FIG. 20 is a view illustrating the contents of data stored in an RIP job management data part. FIG. 21 is a flow chart explaining the RIP host selection procedure in an RIP host selection function part shown in FIG. 18. FIG. 22 is a flow chart explaining the operation of a print client or a third party client of the distributed printing system of FIG. 18. FIG. 23 is a flow chart explaining the operation of a printer controller corresponding to the operation of the print client or the third party client shown in FIG. 22.

The distributed printing system shown in FIG. 18 is substantially the same as that of FIG. 7 except for the provision of PDL analysis function parts 13b one for each of a print client 401 and a third party client 404 as well as the processing of a printer controller according to the PDL analysis function parts. In the distributed printing system shown in FIG. 18, the third party client 404 can communicate with both of the print client 401 and the printer controller 402, and the respective parts of the same names have the same functions and are comprised of a computer which has substantially the same function as that of the print client 401 as a whole. Moreover, in the RIP host selection procedure, the third party client 404 is an RIP host's candidate, and the data of the third party client 404 is stored in an RIP host data part 22 as shown in FIG. 19. In addition, an RIP job management data part 23c stores job numbers JBa, JBb, JBc, - - - , JBn, and order numbers 3, 1, 2, - - - , (n−1) of raster image processing for the PDL data of the job numbers, respectively, as shown in FIG. 20 for instance.

The RIP host selection procedure of the RIP host selection function part 21 in the distributed printing system of FIG. 18 will be described while referring to FIG. 19 and FIG. 21. Stored in the RIP host data part 22 of the printer controller 402 are the print client 401, the printer controller 402 and the third party client 404 as RIP host's candidates, as shown in FIG. 19. That is, the presence or absence of raster image processing permission for each of them, the clock frequency of the CPU and the capacity of the memory are registered. The RIP host selection procedure in the fourth embodiment of FIG. 18 is different from that in the third embodiment in these registrations. The difference between the procedures is mainly an RIP host selection procedure when the printer controller 402 is not selected as an RIP host. The portion of the procedure for determining from information on the RIP host data whether there is RIP permission for the print client in the third embodiment of FIG. 12 is constructed according to the fourth embodiment in such a manner that data related to RIP permissions for the print client 401 and the third party client 404 are held, and that either one of the print client and the third party client which is regarded as better suited to computation processing can be automatically selected as an RIP host based on the CPU performance and the memory size of each client when it becomes necessary to select either one of the print client and the third party client

That is, the RIP host selection function part 21 of the printer controller 402 is waiting for raster image processing based on the number of pages of the PDL data that has been sequentially analyzed by the PDL analysis function parts 13b of the print client 401 and the third party client 404 and sent to the printer controller 402, and the number of pages X will be calculated by adding the number of pages PG1 of the PDL data newly requested of raster image processing to the total number of pages PG0 of all the PDL data stored in the RIP spool (SK1). Next, it is determined whether the number of pages X thus calculated is less than a prescribed threshold α (SK2). When the number of pages X is less than the threshold α, the printer controller 402 is selected as an RIP host (SK3). When it is determined in step SK2 that the number of pages X is equal to or greater than the threshold α, the print client 401 and the third party client 404, which are computers other than the printer controller 402 and which can be made RIP host's candidates, are applied with identifiers X1 and X2, respectively, so that they can be handled as objects for determination (SK4).

Thus, the RIP host selection function part 21 initializes the max value, which is a parameter representative of the performance of an RIP host (SK5). A loop for determination is set for all of the computers which can be made RIP host's candidates or objects (the print client and the third party client in this example) (SK6; the meaning of the processing located between step SK6 and step SK11 is that the processing from step SK7 up to step SK10 prior to step SK11 is repeated for the objects or candidates set in step SK6, and the control process is then shifted to step SK12 following the step SK11.). In the fourth embodiment, RIP host's objects to be selected are two, i.e., the print client 401 and the third party client 404, so this loop is set so as to perform two processings (i=1 to 2) in step SK6.

After the setting in step SK6 has been completed, a parameter representative of the performance of the computer, which is the object of determination, is calculated. This parameter is calculated based on the data registered in the RIP host data part 22. In the fourth embodiment, the clock frequency at which the CPU operates and the memory size are multiplied by constants γ and δ, respectively, and then summed up with each other to provide a total sum. In this case, the constants γ and δ are of prescribed values decided beforehand, and hence the higher the calculation performance of the computer, the greater will be the value of the total sum calculated herein (SK7). It is then determined whether there is raster image processing permission for a computer Xi whose performance is to be determined, and whether the value representative of the processing performance of the computer calculated in step SK7 is greater than that of another computer already determined (SK8). When it is found as a result of the determinations in step SK8 that the computer to be determined has RIP permission, and that the value representing the calculation performance thereof is higher than that of the other computer thus far determined as an RIP host selection object or candidate, the computer to be determined is made an RIP host (SK9) and the value representative of the performance of this computer is saved as a max value (SK10). Subsequently, it is determined whether the max value is in the initial state (SK12), and if so, there is no candidate for the RIP host, and hence the RIP host is made the printer controller 402 (SK13). When it is determined in step SK12 that the max value is not in the initial state, the print client 401 of identifier X1 or the third party client 404 of identifier X2 decided as an RIP host is made the RIP host (SK14).

The operation of the print client or the third party client in the distributed printing system of FIG. 18 will now be described while referring to FIG. 22. In this case, only the print client will be referred to because the operations of both of them are substantially the same. The print client 401 determines whether there is a print request from a user (SL1). When there is no print request as a result of the determination, it is further determined whether there is a request for raster image processing from the printer controller 402 (SL2). When there is no RIP request as a result of the determination, it is determined whether there is a request for receiving the PDL data sent from the printer controller 402 (SL3). When there is no request for the PDL data reception as a result of the determination, it is determined whether there is a request for transmitting the PDL data from the printer controller 402 (SL4). When there is no request for PDL data transmission, the control process is ended, whereas when there is a request for PDL data transmission, the PDL data is transmitted to the printer controller 402 (SL5).

If there is a print request from the user in the above-mentioned step SL1, the print client 401 creates PDL data (SL6), and the PDL analysis function part 13b extracts PDL feature data (SL7). The client RIP management function part 13 transmits a print request and the PDL feature data to the printer controller 302 through the communications function part 19 and the communications means TRA (SL8). (This print request is transmitted to the printer controller 402, for instance, through steps SL4 and SL5 or as a raster data through steps SL2, SL9 and SL10 in accordance with the next control operation.) When there is a RIP request from the printer controller 402 in step SL2, the printer controller itself becomes an RIP host, and the raster image processing of the PDL data concerned is performed (SL9). The raster data after having been subjected to the raster image processing is transmitted to the printer controller 402 (SL10). When it is determined in step SL3 that there is a request for receiving the PDL data sent from the printer controller 402, the PDL data is received (SL10). In the case of step SL10, a request for performing raster image processing of the PDL data concerned from the printer controller 402 is usually received in the next operation, and hence the print client 401 creates and transmits raster data through steps SL2, SL9 and SL10.

As can be seen from the above description about FIG. 21 and FIG. 22, the printer controller 402 in this example performs raster image processing for PDL data requesting such processing in principle by itself, but when processing is congested, the printer controller selects as an RIP host either one of the print client 401 and the third party client, which is better suited to the processing, so that the raster image processing is carried out by the thus selected one. In addition, the PDL data, for which a print request is made from the print client 401, may be delivered to the third party client 404, or the PDL data, for which a print request is made from the third party client 404, may be delivered to the print client 401, so that the PDL data can be subjected to the raster image processing.

Then, reference will be made to the operation of the printer controller corresponding to the operation of the print client or the third party client shown in FIG. 18 while referring to FIG. 23. The printer controller 402 determines whether there exists the presence or absence of a print request from the print client 401 or the third party client 404 (SM1). When there is no print request, it is determined whether there exists any raster data which has been subjected to raster image processing (SM2), and if no such raster data exists, the control process is ended, whereas if there exists some such raster data, the raster data is output to the printer engine 403 (SM3). When there is a print request in step SM1, an RIP host is selected in accordance with the operation shown in FIG. 21 (SM4). It is then determined whether the RIP host thus selected is the printer controller 402 (SM5).

When the printer controller 402 is the RIP host as a result of the determination in step SM5, the printer controller 402 performs the raster image processing corresponding to the print request (SM6), and then proceeds to step SM3 where raster data is output. On the other hand, when it is determined in step SM5 that the RIP host is not the printer controller 402, it is further determined whether the RIP host is the print client 401 (SM7). If so, a request for receiving the transmission of the PDL data is made to the print client 401 (SM8), and the PDL data is transmitted (SM9). After the transmission of the PDL data has been completed, the printer controller 402 transmits a request to the print client 401 such that the print client 401 performs the raster image processing for the transmitted PDL data (SM10).

When it is determined in step SM7 that the RIP host is not the print client 401, the RIP host is the third party client 404, so the printer controller 402 makes a request for receiving the transmission of the PDL data to the third party client 404 (SM11) and transmits the PDL data thereto (SM12). After the transmission of the PDL data has been completed, the printer controller 402 transmits a request such that the third party client 404 should perform the raster image processing for the transmitted PDL data (SM13). Here, note that although in this example, the printer controller 402 delivers raster image processing to the print client 401 or the third party client 404 as necessary after having received the PDL data from the print client 401 or the third party client 404, control may be carried out in such a manner that the PDL data is transmitted directly between the print client 401 and the third party client 404.

(Embodiment 5)

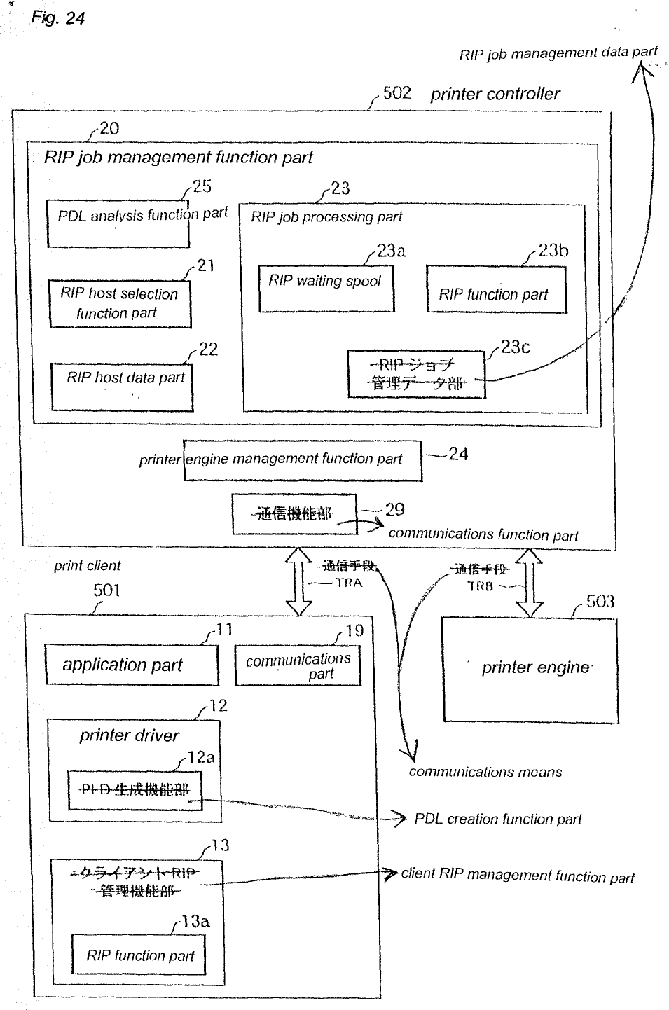

Next, a fifth embodiment of a distributed printing system of the present invention will be described while referring to the drawings. FIG. 24 is a block diagram illustrating the construction of the fifth embodiment of the distributed printing system of the present invention. This distributed printing system includes a print client 501, a printer controller 502 and a printer engine 503, and as compared with the third embodiment of FIG. 12 it is different therefrom in that the print client 501 does not have a PDL analysis function part, and that the printer controller 502 has a PDL analysis function part, but this fifth embodiment is the same as the third embodiment in other respects. Therefore, a description of the operation of this distributed printing system is omitted. Such a construction is advantageous in cases where the ability of the printer controller 502 is by far greater than that of the print client 501.

(Embodiment 6)

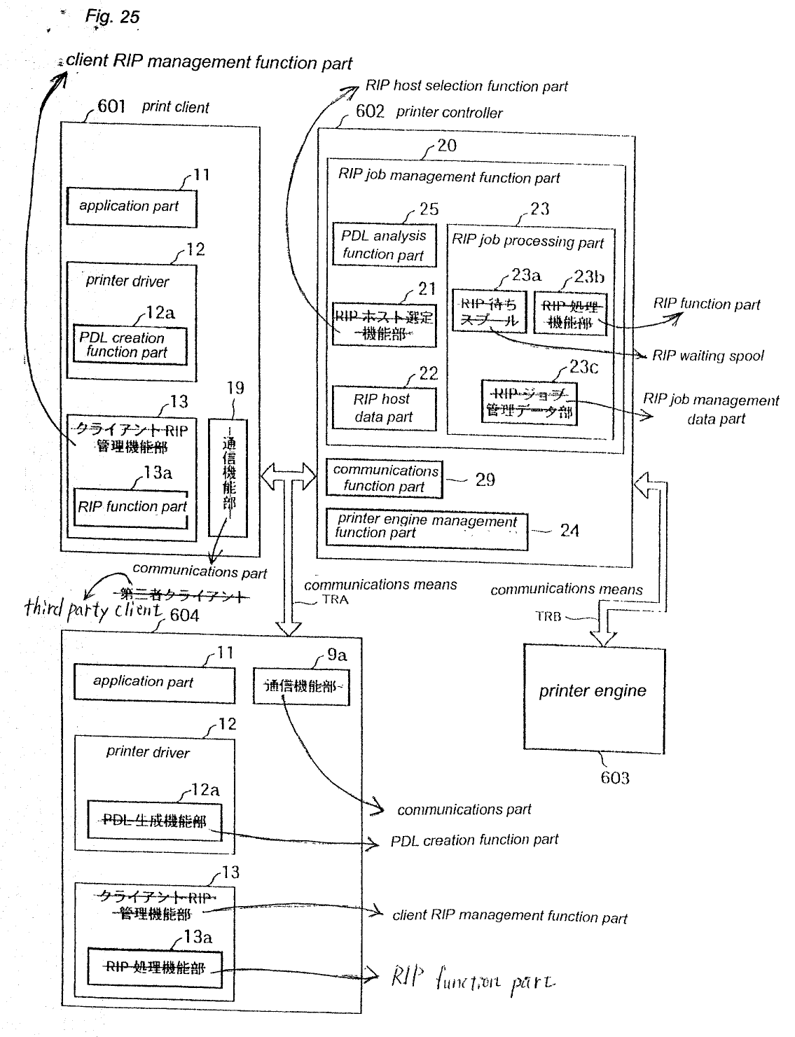

Next, a sixth embodiment of a distributed printing system of the present invention will be described while referring to the drawings. FIG. 25 is a block diagram illustrating the construction of the sixth embodiment of the distributed printing system of the present invention. This distributed printing system includes a print client 601, a printer controller 602 and a printer engine 603, and as compared with the fourth embodiment of FIG. 18, it is different therefrom in that the print client 601 and the third party client 604 do not have a PDL analysis function part, and that the printer controller 602 has a PDL analysis function part 25, but this sixth embodiment is the same as the fourth embodiment in other respects. Therefore, an explanation of the operation of this distributed printing system is omitted. Such a construction is advantageous in cases where the ability of the printer controller 602 is by far greater than that of the print client 601 or the third party client 604.

(Embodiment 7)

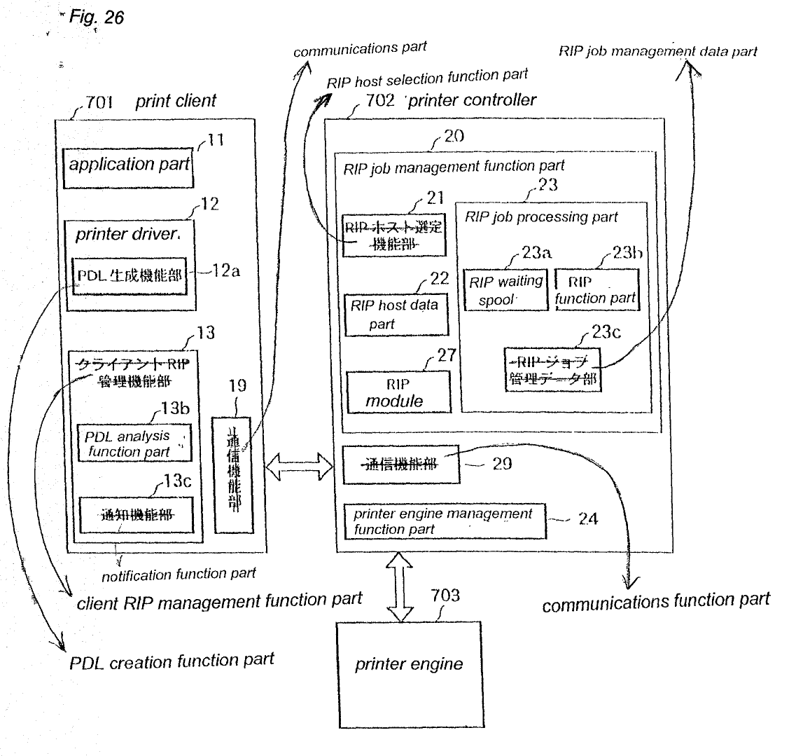

Next, a seventh embodiment of a distributed printing system of the present invention will be described while referring to the drawings. FIG. 26 is a block diagram illustrating the construction of the seventh embodiment of the distributed printing system of the present invention. This distributed printing system includes a print client 701, a printer controller 702 and a printer engine 703, and as compared with the third embodiment of FIG. 12, it is different therefrom in that the print client 701 does not have an RIP function part but instead have a notification function part 13c. In addition, the printer controller 702 has an RIP module 27, and is accordingly different in operation.

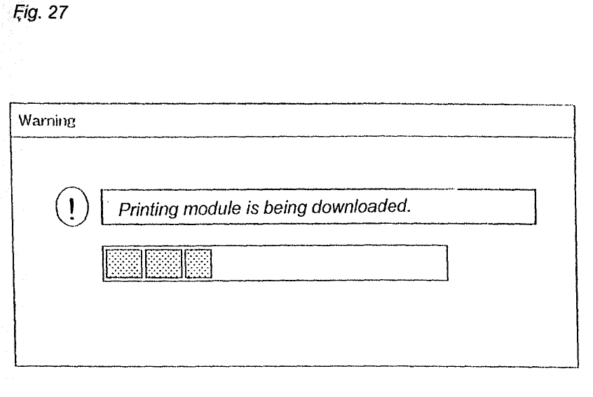

Although in the above-mentioned distributed printing system, an operation similar to that of the first embodiment of FIG. 1 is performed when the printer controller 702 is selected as an RIP host, the printer controller 702 transmits a RIP request and the contents of the RIP module 27 to the print client 701 when the print client 701 is selected as an RIP host. In the print client 701 receiving these, the notification function part 13c of the client RIP management function part 13 makes a request for downloading the contents of the RIP module 27 to the printer controller 702. When the notification function part 13c begins to download the contents of the RIP module 27 in accordance with the request, an indication is carried out on a display as shown in FIG. 27. Thereafter, when the notification function part 13c has completed downloading, the client RIP management function part 13 performs the raster image processing of the PDL data by using the received contents, and creates raster data and transmits it to the printer controller 702. According to this example, the raster image processing can be performed for the print client which does not have a raster image processing function. In this case, it is possible to inquire through the display of the print client 701 whether downloading is permitted when the printer controller 702 receives a request for downloading. If the downloading is not admitted, the printer controller 702 carries out the processing.

(Embodiment 8)

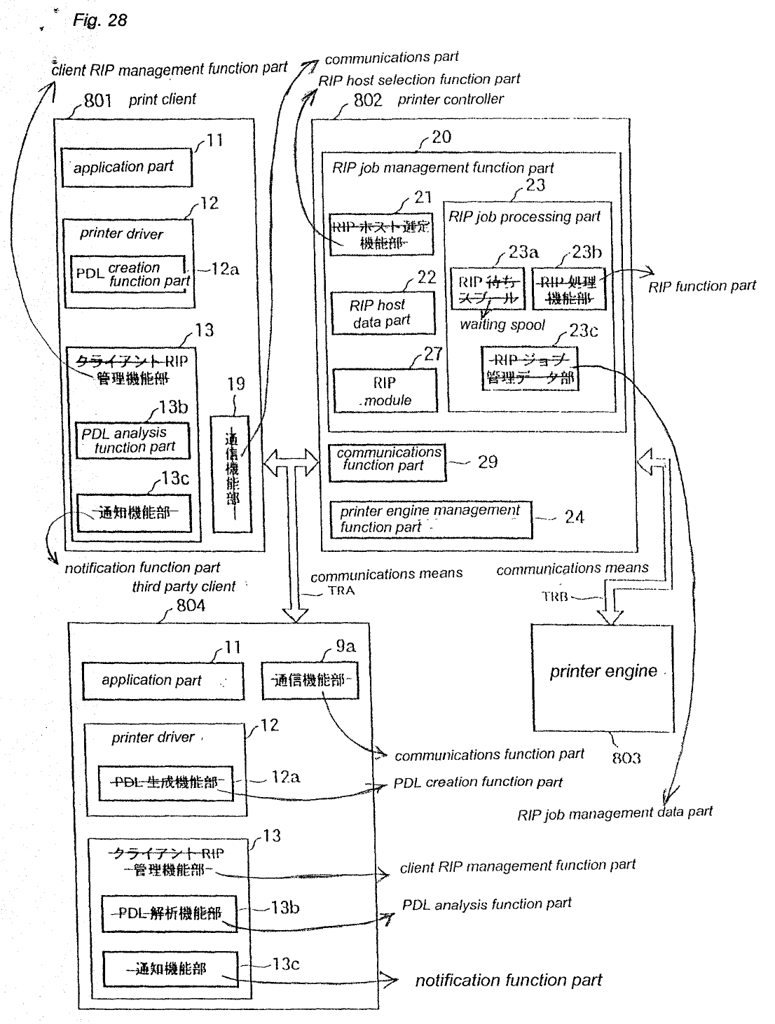

Next, an eighth embodiment of a distributed printing system of the present invention will be described while referring to the drawings. FIG. 28 is a block diagram illustrating the construction of the eighth embodiment of the distributed printing system of the present invention. This distributed printing system includes a print client 801, a printer controller 802, a printer engine 803 and a third party client 804, but as compared with the fourth embodiment of FIG. 18, it is different therefrom in that each of the print client 801 and the third party client 804 does not have an RIP function part but instead a notification function part 13c. In addition, the printer controller 802 has an RIP module 27, and the operation thereof is accordingly different. In this case, when the print client 801 or the third party client 804 is selected as an RIP host, the printer controller 802 performs an operation similar to that of the seventh embodiment of FIG. 26 for the print client 801 or third party client 804 thus selected. Also, in this case, it is possible to inquire through the display of the print client 801 or the third party client 804 whether downloading is permitted when the printer controller 802 receives a request for downloading. In this case, an RIP host is selected from among those which do not refuse downloading.

(Embodiments 9 and 10)

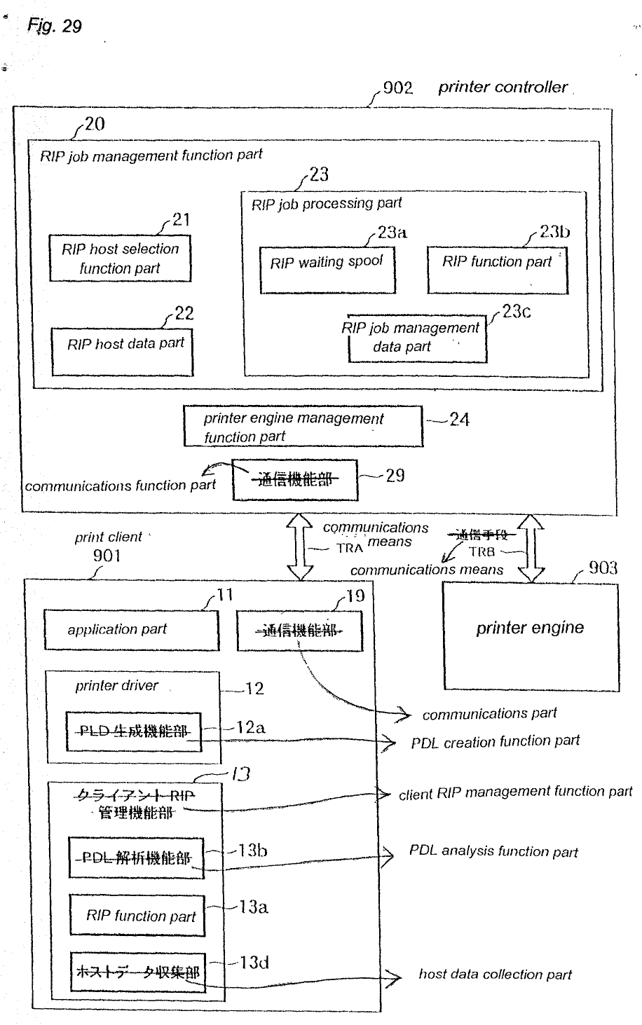

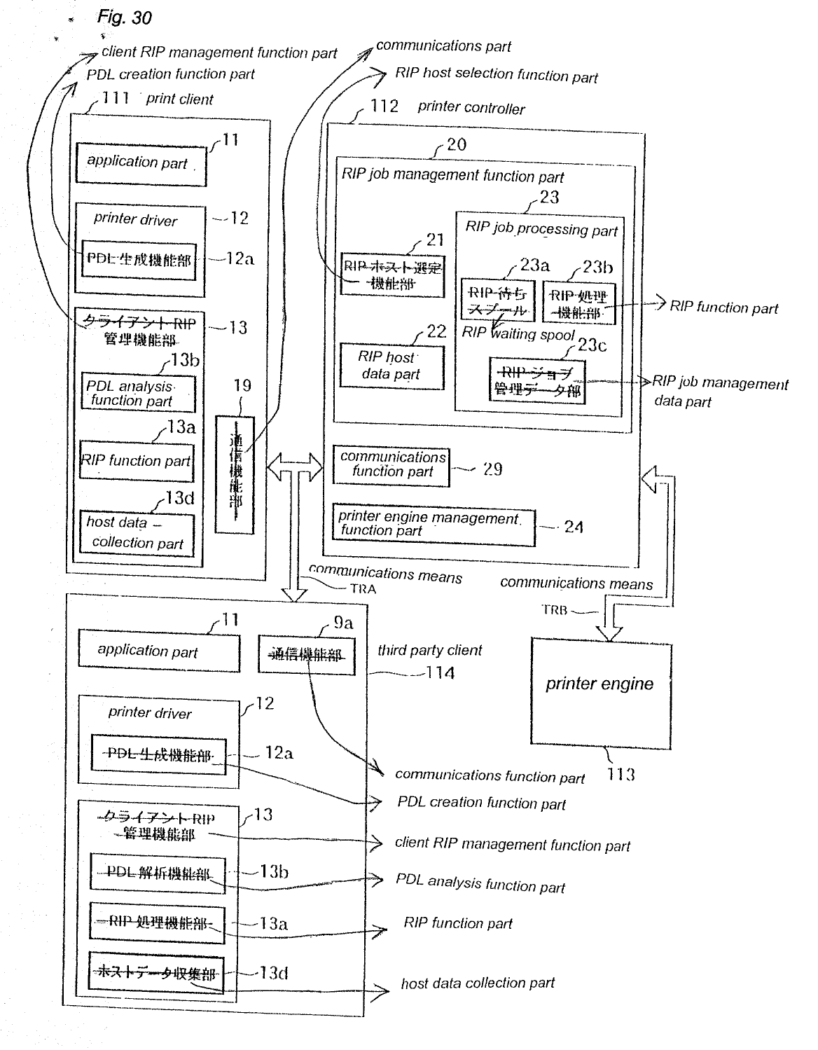

Next, a ninth embodiment of a distributed printing system of the present invention will be described while referring to the drawings. FIG. 29 is a block diagram illustrating the construction of the ninth embodiment of the distributed printing system of the present invention. This distributed printing system includes a print client 901, a printer controller 902 and a printer engine 903, but as compared with the third embodiment of FIG. 12, it is different therefrom in that a client RIP management function part 13 of the print client 901 has a host data collection part 13d, and the operation of the printer controller 902 is accordingly different. Moreover, FIG. 30 is a block diagram illustrating the construction of a tenth embodiment of a distributed printing system of the present invention, which includes a print client 111, a printer controller 112, a printer engine 113 and a third party client 114. However, as compared with the fourth embodiment of FIG. 18, this embodiment is different therefrom in that each of the client RIP management function parts 13 of the print client 111 and the third party client 114 has a host data collection part 13d, and the operation of the printer controller 902 is accordingly different.

In the distributed printing systems of FIG. 29 and FIG. 30, the host data collection part 13d collects host data at appropriate times, transmits it to the printer controller, and dynamically updates the contents of data in the RIP host data part 22. The printer controller instructs the RIP job management function part 20 upon selection of an RIP host, so that the host selection function part 21 and the RIP host data part 22 are driven to select the best RIP host based on the contents of the host data part 21 dynamically updated. The RIP host thus selected operates in the same manner as the RIP host in FIG. 12 or FIG. 18 does, and performs raster image processing efficiently.

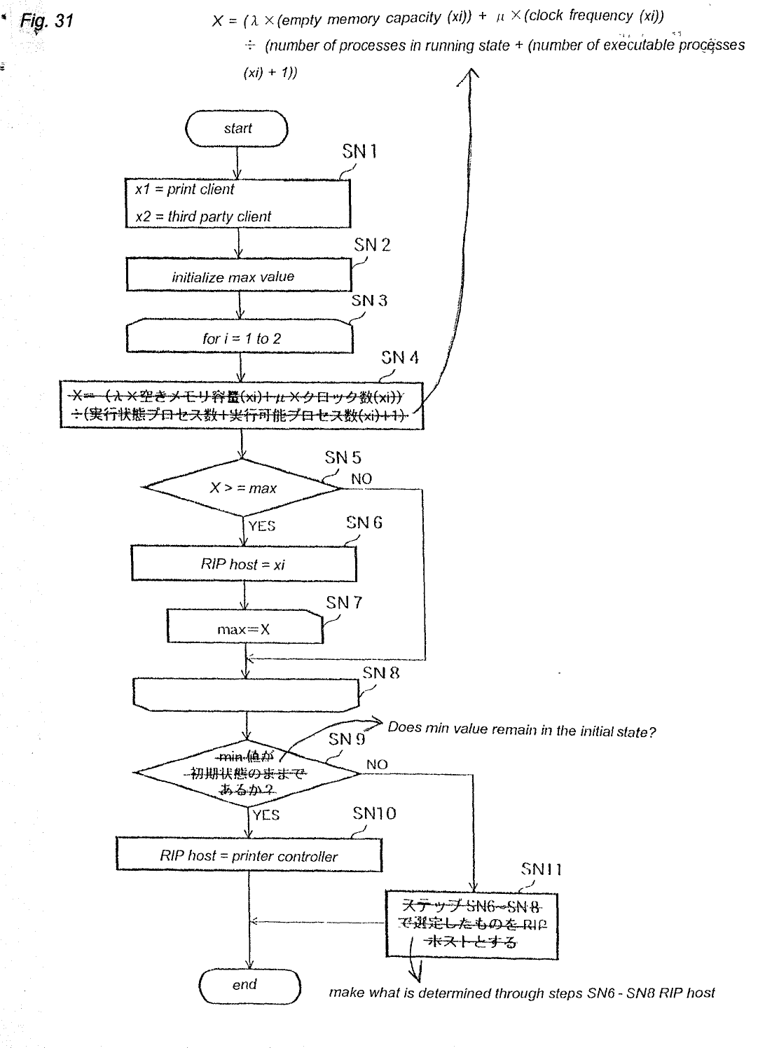

Now, reference will be briefly made to an operation in which the printer controller 112 selects an RIP host in the above-mentioned distributed printing system of FIG. 30, while referring to FIG. 31. The print client 111 and the third party client 114, which are computers other than the printer controller 112 and can be made RIP host's candidates, are applied with identifiers X1 and X2, respectively, so that they can be handled as objects for determination (SN1). Then, the RIP host selection function part 21 of the printer controller 112 initializes a max value which is a parameter representative of the RIP host performance (SN2). A loop for determination is set for all the computers (the print client and the third party client in this example) which can be RIP host's objects or candidates (SN3; the meaning of the processing located between step SN3 and step SN8 is that the processing from step SN4 up to step SN7 prior to step SN8 is repeated for the objects set in step SN3, and the control process is then shifted to step SN9 following the step SN8.). In the tenth embodiment, the RIP host's objects to be selected is two, the print client 111 and the third party client 114, so this loop is set so as to perform two processings (i=1 to 2) in step SN6.

After the setting in step SN6 has been completed, a parameter representative of the performance of each computer which is the object of determination is calculated. This parameter is calculated according to the following expression based on the data registered in the RIP host data part 22. That is, the parameter X is calculated as follows:

X=(λ×(empty memory capacity of xi)+μ×(clock frequency of xi))÷(number of processes in running state+(number of executable processes of xi+1))

In this case, constants λ and μ are the values decided beforehand. The higher the calculation performance of a computer, the greater becomes the value X calculated here (SN4). It is then determined whether there is raster image processing permission for a computer Xi whose performance is to be determined, and whether the value representative of the processing performance of the computer calculated in step SN4 is greater than that of another computer already determined (SN5).

When it is found as a result of the determinations in step SN5 that the computer to be determined has RIP permission, and that the value representing the calculation performance thereof is higher than that of the other computer thus far determined as an RIP host selection object, the computer to be determined is made an RIP host (SN6), and the value representative of the performance of this computer is saved as a max value (SN7). Subsequently, it is determined whether the max value is in the initial state (SN9), and if so, there is no candidate for an RIP host, and hence the printer controller 112 is made an RIP host (SN10). When the max value is not in the initial state in step SN9, the print client 111 or third party client 114 of identifier X1 or X2, which has been decided as an RIP host, is made the RIP host (SN11). Here, note that the operations of the print client and the third party client in the distributed printing systems of FIG. 29 and FIG. 30 are substantially similar to those in the distributed printing systems of FIG. 12 and FIG. 18 excepting that the RIP host data at appropriate times is transmitted at those times to the printer controller to dynamically update the host data, and hence a further description thereof is omitted.

(Embodiment 11)

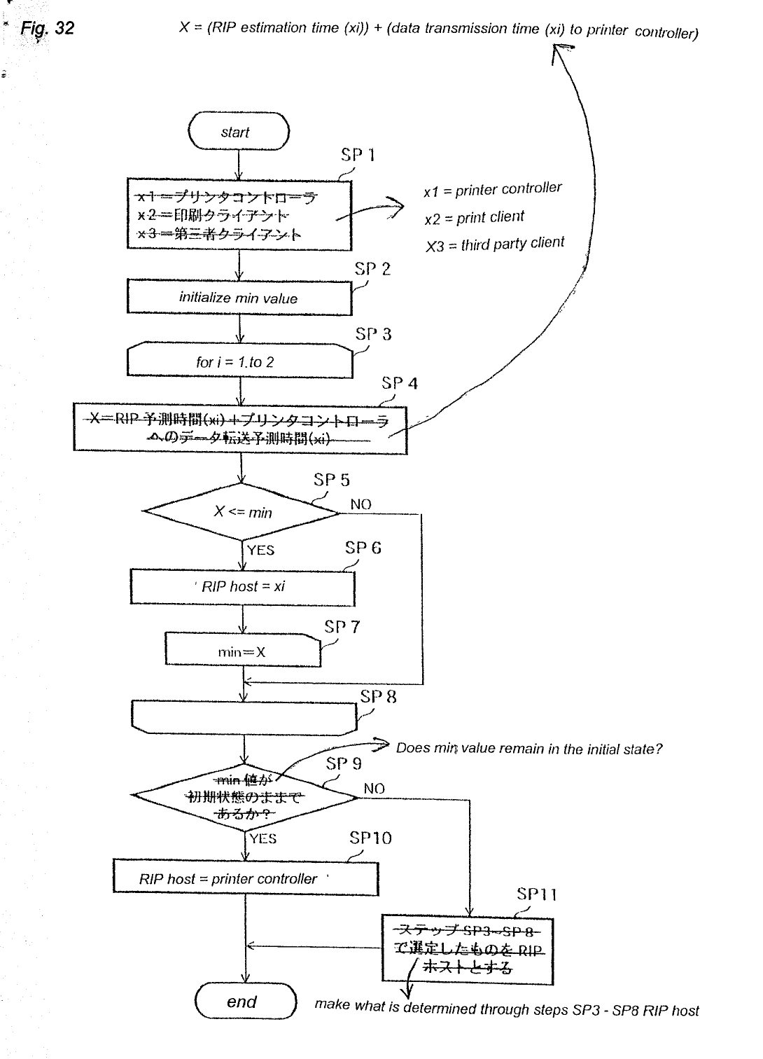

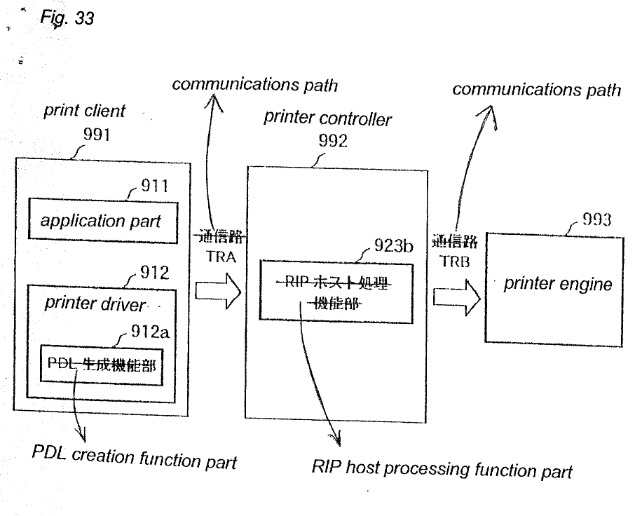

In some of the above-mentioned distributed printing systems, an RIP estimation time, which is the time required for raster image processing, is taken as a determination reference or criterion for the selection of an RIP host, and in this case, accurate determination can be often made if an estimation time for data transmission to the print controller is taken into consideration. An example of this in the form of an eleventh embodiment of the present invention will be briefly described below while referring to a flow chart of FIG. 32. Here, the printer controller, the print client and the third party client, which can be made RIP host's candidates, are applied with identifiers X1, X2 and X3, respectively, so that they can be handled as objects for determination (SP1). After initialization of the max value (SN2), by using the following expression, it is determined which one of the printer controller, the print client and the third party client has a parameter X of the least value (SP3-SP11).

X=(RIP estimation time of xi)+(data transmission time of xi to printer controller)

Further modifications of the above-mentioned embodiments will be described below For instance, (total number of pages calculated in step SA1)×(average raster image processing time per page) may be calculated instead of the total number of pages x calculated in step SA1 shown in FIG. 4, and in step A2, the value thus calculated is compared with a threshold. In the cases of FIG. 18 and FIG. 25, too, in order to determine whether the raster image processing should be performed by someone other than the printer controller itself, it may be possible to calculate (total number of pages)×(average raster image processing time per page) and compare the value thus calculated with a threshold.

According to the distributed printing systems and the distributed printing methods of the present invention which are constructed as described above, raster image processing can be appropriately distributed among and performed by a print client and a printer controller(s). Thus, there will be obtained an effect that even if print requests rush into the printer controller, the raster image processing can be appropriately distributed among and processed by the print client(s) and the printer controller, so that the raster image processing can be prevented from stagnating in the printer controller, thereby making it possible to efficiently transmit raster data to a printer engine.

What is claimed is:

1. A distributed printing system comprising: a print client for creating PDL data based on a print request of a user;
a printer controller for delivering raster data, which is created by subjecting the PDL data created by said print client to raster image processing, to a printer engine so as to be printed thereby; and
RIP distribution control means capable of making the raster image processing distributed among and performed by said print client and said printer controller.

2. The distributed printing system as set forth in claim 1, characterized in that said RIP distribution control means distributes the raster image processing based on an amount of accumulation of the PDL data waiting for the raster image processing.

3. The distributed printing system as set forth in claim 2, characterized in that said RIP distribution control means determines the amount of accumulation of said PDL data based on PDL feature data corresponding to an amount of raster image processing of said PDL data.

4. The distributed printing system as set forth in claim 1, characterized in that said RIP distribution control means distributes the raster image processing based on RIP host data which is data related to the processing performance of said print client.

5. The distributed printing system as set forth in claim 4, characterized in that said processing performance includes at least one of a raster image processing speed, a memory capacity, and a data transmission time.

6. The distributed printing system as set forth in claim 1, characterized in that said RIP distribution control means comprises RIP function parts arranged in said printer controller and said print client, respectively; and RIP host selection control means arranged in said printer controller for determining, upon receipt of a notification of transmission of PDL data from said print client, whether an amount of accumulation of PDL data waiting for raster image processing when the PDL data to be transmitted from said print client is received becomes equal to or greater than a prescribed threshold, and for issuing an instruction such that said print client performs raster image processing of said PDL data by using its own RIP function part when the amount of accumulation of PDL data waiting for raster image processing becomes equal to or greater than said threshold.

7. The distributed printing system as set forth in claim 6, characterized in that a plurality of print client members are arranged as said print client; and said RIP host selection control means comprises: an RIP host data part arranged in said printer controller for storing RIP host data which is data related to the processing performance of each print client member; and an RIP host selection function part for selecting one of said plurality of print client members which has the highest processing performance while referring to the RIP host data when the amount of accumulation of said PDL data waiting for raster image processing becomes equal to or greater than a prescribed threshold, and for instructing the print client member thus selected in such a manner that raster image processing of said PDL data is carried out by said selected print client member while using its own RIP function part.

8. The distributed printing system as set forth in claim 6, characterized in that RIP execution permission means is provided in said RIP function part arranged in each print client member in such a manner that the user can preset whether an instruction of raster image processing from said printer controller is acceptable.

9. The printing system as set forth in claim 8, characterized in that a plurality of print client members are arranged as said print client; and said RIP host selection control means comprises: an RIP host data part arranged in said printer controller for storing RIP host data which is data related to the processing performance of each print client member; and an RIP host selection function part for selecting those of said plurality of print client members which said RIP execution permission means permits acceptance of an raster image processing instruction from said printer controller when the amount of accumulation of said PDL data waiting for raster image processing becomes equal to or greater than a prescribed threshold, further selecting one of the thus selected print client members which has the highest processing performance while referring to the RIP host data, and instructing the print client member thus selected in such a manner that raster image processing of said PDL data is carried out by said selected print client member while using its own RIP function part.

10. The printing system as set forth in claim 1, characterized in that said RIP distribution control means comprises: RIP function parts arranged in said printer controller and said print client, respectively; a PDL analysis function part arranged in said print client for extracting PDL feature data corresponding to an amount of raster image processing of the PDL data; and RIP host selection control means arranged in said printer controller for determining, upon receipt of a notification of transmission of PDL data from said print client, based on the PDL feature data from said PDL analysis function part whether the amount of accumulation of PDL data waiting for raster image processing when the PDL data to be transmitted from said print client is received becomes equal to or greater than a prescribed threshold, and for issuing an instruction such that said print client performs raster image processing of said PDL data by using its own RIP function part when the amount of accumulation of PDL data waiting for raster image processing becomes equal to or greater than said threshold.

11. The printing system as set forth in claim 10, characterized in that the PDL feature data extracted by said PDL analysis function part comprises the number of pages of the PDL data.

12. The distributed printing system as set forth in claim 10, characterized in that a plurality of print client members are arranged as said print client; and said RIP host selection control means comprises: an RIP host data part arranged in said printer controller for storing RIP host data which is data related to the processing performance of each print client member; and an RIP host selection function part for selecting one of said plurality of print client members which has the highest processing performance while referring to the RIP host data when the amount of accumulation of said PDL data waiting for raster image processing becomes equal to or greater than a prescribed threshold, and for instructing the print client member thus selected in such a manner that raster image processing of said PDL data is carried out by said selected print client member while using its own RIP function part.

13. The distributed printing system as set forth in claim 1, characterized in that said RIP distribution control means comprises: RIP function parts arranged in said printer controller and said print client, respectively; a PDL analysis function part arranged in said printer controller for extracting PDL feature data corresponding to an amount of raster image processing of the PDL data; and RIP host selection control means for determining, upon receipt of a notification of transmission of PDL data from said print client, based on the PDL feature data from said PDL analysis function part whether an amount of accumulation of PDL data waiting for raster image processing when the PDL data to be transmitted from said print client is received becomes equal to or greater than a prescribed threshold, and for issuing an instruction such that said print client performs raster image processing of said PDL data by using its own RIP function part when the amount of accumulation of PDL data waiting for raster image processing becomes equal to or greater than said threshold.

14. The distributed printing system as set forth in claim 13, characterized in that a plurality of print client members are arranged as said print client; and said RIP host selection control means comprises: an RIP host data part arranged in said printer controller for storing RIP host data which is data related to the processing performance of each print client member; and an RIP host selection function part for selecting one of said plurality of print client members which has the highest processing performance while referring to the RIP host data when the amount of accumulation of said PDL data waiting for raster image processing becomes equal to or greater than a prescribed threshold, and for instructing the print client member thus selected in such a manner that raster image processing of said PDL data is carried out by said selected print client member while using its own RIP function part.

15. The distributed printing system as set forth in claim 1, characterized in that said RIP distribution control means comprises: a PDL analysis function part arranged in said print client for extracting PDL feature data corresponding to an amount of raster image processing of the PDL data, and a notification function part having a function of downloading control data from said printer controller; and RIP host selection control means arranged in said printer controller for determining, upon receipt of a notification of transmission of PDL data from an RIP module storing a control program for raster image processing and from said print client, based on the PDL feature data extracted by said PDL analysis function part whether an amount of accumulation of PDL data waiting for raster image processing when the PDL data to be transmitted is received becomes equal to or greater than a prescribed threshold, and for sending control data of said RIP module to said print client when the amount of accumulation of PDL data waiting for raster image processing becomes equal to or greater than said threshold, and issuing an instruction such that said print client performs raster image processing of said PDL data by using the control data received by said print client.

16. The distributed printing system as set forth in claim 15, characterized in that a plurality of print client members are arranged as said print client; and said printer controller selects one of said plurality of print client members which has the highest processing performance while referring to the RIP host data when the amount of accumulation of said PDL data waiting for raster image processing becomes equal to or greater than a prescribed threshold, and makes said notification function part of the print client member thus selected download a control program for raster image processing sent from said RIP module.

17. The distributed printing system as set forth in claim 7, characterized in that a host data collection part for collecting RIP host data of each print client member and transmitting the RIP host data thus collected to the RIP host data part at appropriate times is arranged in each print client member.

18. A distributed printing method comprising:
a PDL data creation step for creating PDL data in a print client based on a print request of a user;
a distribution step for distributing said PDL data to said print client and a printer controller;
a raster image processing step for acquiring raster data by performing raster image processing of the distributed PDL data in said print client or said printer controller; and
a printing step for delivering the raster data acquired through the raster image processing to a printer engine to print the raster data.

19. The distributed printing method as set forth in claim 18, characterized in that in said distribution step, the raster image processing is distributed based on an amount of accumulation of the PDL data waiting for raster image processing.

20. The distributed printing method as set forth in claim 19, characterized in that the amount of accumulation of said PDL data is determined based on PDL feature data corresponding to an amount of raster image processing of the PDL data.

21. The distributed printing method as set forth in claim 18, characterized in that in said distribution step, the raster image processing is distributed based on RIP host data which is data related to the processing performance of said print client.

22. The distributed printing method as set forth in claim 21, characterized in that said processing performance includes at least one of a raster image processing speed, a memory capacity, and a data transmission time.

23. The distributed printing method as set forth in claim 18, characterized in that said distribution step comprises: a determination step for determining, upon receipt of a notification of transmission of PDL data from said print client, in said print controller whether an amount of accumulation of the PDL data waiting for raster image processing when the PDL data to be transmitted is received becomes equal to or greater than a prescribed threshold; and an RIP host selection step for issuing an instruction such that said print client performs raster image processing of said PDL data by using its own RIP function part when the amount of accumulation of the PDL data becomes equal to or greater than said threshold.

24. The distributed printing method as set forth in claim 23, characterized in that in said RIP host selection step, one of a plurality of print client members which has the highest processing performance is selected, and an instruction is issued to the print client member thus selected in such a manner that raster image processing of said PDL data is carried out by said selected print client member while using its own RIP function part.

25. The distributed printing method as set forth in claim 23, characterized in that an RIP execution permission step is provided in each print client member in such a manner that the user can preset whether an raster image processing instruction from said printer controller is acceptable.

26. The distributed printing method as set forth in claim 25, characterized in that said RIP host selection step comprises: a step for selecting those of said plurality of print client members which are permitted to accept an raster image processing instruction from said printer controller in the RIP execution permission step; a step for referring to RIP host data for the print client members thus selected; and a step for further selecting one of the selected print client members which has the highest processing performance; wherein an instruction is given to the selected print client member such that the PDL data is subjected to raster image processing by using its own RIP function part.

27. The distributed printing method as set forth in claim 18, characterized in that said distribution step comprises: a step for extracting PDL feature data corresponding to an amount of raster image processing of the PDL data; a determination step for determining, upon receipt of a notification of transmission of PDL data from said print client to said print controller, based on the PDL feature data whether an amount of accumulation of the PDL data waiting for raster image processing when the PDL data to be transmitted is received becomes equal to or greater than a prescribed threshold; and an RIP host selection step for issuing an instruction such that said print client performs raster image processing of the PDL data by using its own RIP function part when the amount of accumulation of the PDL data becomes equal to or greater than said threshold.

28. The distributed printing method as set forth in claim 27, characterized in that said step for extracting PDL feature data is performed on a print client side.

29. The distributed printing method as set forth in claim 27, characterized in that said step for extracting PDL feature data is performed on a printer controller side.

30. The distributed printing method as set forth in claim 27, characterized in that said PDL feature data comprises the number of pages of the PDL data.

31. The distributed printing method as set forth in claim 27, characterized in that in said RIP host selection step, when there are a plurality of print client members, one of the plurality of print client members having the highest processing performance is selected, and an instruction is given to the selected print client member so that said PDL data is subjected to raster image processing by using its own RIP function part.

32. The distributed printing method as set forth in claim 23, characterized in that said RIP host selection step includes a step for transmitting control data of an RIP module from said printer controller to said print client when it is determined that the amount of accumulation of the PDL data becomes equal to or greater than said threshold, and for issuing an instruction such that said print client performs raster image processing of the PDL data by using the control data received.

33. The distributed printing method as set forth in claim 32, characterized in that when said print client comprises a plurality of print client members, one of said print client members which has the highest processing performance is selected by referring to RIP host data.

34. The distributed printing method as set forth in claim 23, characterized by comprising a host data collection step for collecting RIP host data of each of print client members and transmitting the RIP host data thus collected to said printer controller at appropriate times.
